(19) United States
(12) Patent Application Publication
(10) Pub. No.: US 2014/0056519 A1
(43) Pub. Date: Feb. 27, 2014

(54) METHOD, APPARATUS AND SYSTEM FOR SEGMENTING AN IMAGE IN AN IMAGE SEQUENCE

(71) Applicant: CANON KABUSHIKI KAISHA, Tokyo (JP)

(72) Inventor: AMIT KUMAR GUPTA, Liberty Grove (AU)

(73) Assignee: CANON KABUSHIKI KAISHA, Tokyo (JP)

(21) Appl. No.: 13/971,014

(22) Filed: Aug. 20, 2013

(30) Foreign Application Priority Data
Aug. 21, 2012 (AU) 2012216341

(51) Int. Cl. G06T 7/00

(52) U.S. Cl. CPC G06T 7/0081
USPC 382/173

(57) ABSTRACT

A method of segmenting an image into foreground and background regions, is disclosed. The image is divided into a plurality of blocks. The plurality of blocks comprises at least a first block of a first size and a second block of a second size. A first plurality of mode models of the first size for the first block and a second plurality of mode models of the second size for the second block are received. If foreground activity in the first block is higher than the foreground activity in the second block, the first size is smaller than the second size. The image is segmented into foreground and background regions based on the received mode models.

### REFERENCE TO RELATED PATENT APPLICATION(S)

This application claims the benefit under 35 U.S.C. §119 of the filing date of Australian Patent Application No. 2012216341, filed 21 Aug. 2012, hereby incorporated by reference in its entirety as if fully set forth herein.

### TECHNICAL FIELD

The present disclosure relates to object detection in videos and, in particular, to a method, apparatus and system for segmenting an image. The present disclosure also relates to a computer program product including a computer readable medium having recorded thereon a computer program for segmenting an image.

### BACKGROUND

A video is a sequence of images. The images may also be referred to as frames. The terms ‘frame’ and ‘image’ are used interchangeably throughout this specification to describe a single image in an image sequence, or a single frame of a video. An image is made up of visual elements. Visual elements may be, for example, pixels or blocks of wavelet coefficients. As another example, visual elements may be frequency domain 8×8 DCT (Discrete Cosine Transform) coefficient blocks, as used in JPEG images. As still another example, visual elements may be 32×32 DCT-based integer-transform blocks as used in AVC or h.264 coding.

Scene modelling, also known as background modelling, involves modelling visual content of a scene, based on an image sequence depicting the scene. A common usage of scene modelling is foreground segmentation by background subtraction. Foreground segmentation may also be described by its inverse (i.e., background segmentation). Examples of foreground segmentation applications include activity detection, unusual object or behaviour detection, and scene analysis.

Foreground segmentation allows a video analysis system to distinguish between transient foreground objects and the non-transient background, through scene modelling of the non-transient background, and a differencing operation between that background and incoming frames of video. Foreground segmentation can be performed as with foreground segmentation, or by using scene modelling and identifying portions of the modelled scene which are either moving, or recently changed/added, or both.

In one scene modelling method, the content of an image is divided into one or more visual elements, and a model of the appearance of each visual element is determined. A visual element may be a single pixel, or a group of pixels. For example, a visual element may be an 8×8 group of pixels encoded as a DCT block. Frequently, a scene model may maintain a number of models for each visual element location, each of the maintained models representing different modes of appearance at each location within the scene model. Each of the models maintained by a scene model are known as “mode models” or “background modes”. For example, there may be one mode model for a visual element in a scene with a light being on, and a second mode model for the same visual element at the same location in the scene with the light off.

The description of a mode model may be compared against the description of an incoming visual element at the corresponding location in an image of the scene. The description may include, for example, information relating to pixel values or DCT coefficients. If the description of the incoming visual element is similar to one of the mode models, then temporal information about the mode model, such as age of the mode model, helps to produce information about the scene. For example, if an incoming visual element has the same description as a very old visual element mode model, then the visual element location can be considered to be established background. If an incoming visual element has the same description as a young visual element mode model, then the visual element location might be considered to be background or foreground depending on a threshold value. If the description of the incoming visual element does not match any known mode model, then the visual information at the mode model location has changed and the location of the visual element can be considered to be foreground.

When choosing the scale of a visual element model, a trade-off exists between detection and precision. For example, in one method, a visual element model represents a small area, such as a single pixel. In such a method, the visual element model may be more easily affected by noise in a corresponding video signal, and accuracy may be affected. A single pixel, however, affords very good precision and small objects and fine detail may be precisely detected.

In another method, a visual element model represents a large area, such as a 32×32 block of pixels. Such an averaged description will be more resistant to noise and hence have greater accuracy. However, small objects may fail to affect the model significantly enough to be detected, and fine detail may be lost even when detection is successful.

In addition to a detection/precision trade-off, there is also a computational and storage trade-off. In the method where a visual element model represents only a single pixel, the model contains as many visual element representations as there are pixels to represent the whole scene. In contrast, if each visual element model represents for example, 8×8=64 pixels, then proportionally fewer visual element representations are needed (e.g., 1/64^{th} as many). If manipulating mode models is relatively more computationally expensive than aggregating pixels into the mode models, then such a trade-off also reduces computation. If aggregating pixels into visual elements is more expensive than processing the pixels, then reducing the size (i.e., increasing the number) can increase efficiency, at the cost of increasing sensitivity to noise.

Computational and storage trade-offs are very important for practical implementation, as are sensitivity to noise, and precision of the output. Currently, a trade-off is chosen by selecting a particular method, or by initialising a method with parameter settings.

Thus, a need exists for an improved method of performing foreground segmentation of an image, to achieve computational efficiency and to better dynamically configure the above trade-offs.

### SUMMARY

It is an object of the present invention to substantially overcome, or at least ameliorate, one or more disadvantages of existing arrangements.

According to a first aspect of the present disclosure, there is provided a method of segmenting an image into foreground and background regions, said method comprising:

dividing the image into a plurality of blocks;

receiving a first plurality of mode models of a first size for a first block and a second plurality of mode models of a second size for a second block, wherein if foreground activity in the first block is higher than the foreground activity in the second block, the first size is smaller than the second size; and

segmenting the image into foreground and background regions based on the received mode models.

According to another aspect of the present disclosure, there is provided an apparatus for segmenting an image into foreground and background regions, said apparatus comprising:

a memory for storing data and a computer program;

a processor coupled to said memory for executing said computer program, said computer program comprising instructions for:
dividing the image into a plurality of blocks;
receiving a first plurality of mode models of a first size for a first block and a second plurality of mode models of a second size for a second block, wherein if foreground activity in the first block is higher than the foreground activity in the second block, the first size is smaller than the second size; and
segmenting the image into foreground and background regions based on the received mode models.

According to still another aspect of the present disclosure, there is provided a computer readable medium comprising a computer program stored thereon for segmenting an image into foreground and background regions, said program comprising:

code for dividing the image into a plurality of blocks;

code for receiving a first plurality of mode models of a first size for a first block and a second plurality of mode models of a second size for a second block, wherein if foreground activity in the first block is higher than the foreground activity in the second block, the first size is smaller than the second size; and

code for segmenting the image into foreground and background regions based on the received mode models.

According to still another aspect of the present disclosure, there is provided a method of segmenting an image into foreground and background regions, said method comprising:

segmenting the image into foreground and background regions by comparing a block of the image with a corresponding block in a scene model for the image, said block of the image and the corresponding block being obtained at a predetermined block size;

accumulating foreground activity in the block of the image based on the segmentation;

altering the block size of the image, in an event that the accumulated foreground activity satisfies a pre-determined threshold; and

determining a further scene model corresponding to the altered block size.

According to still another aspect of the present disclosure, there is provided n apparatus for segmenting an image into foreground and background regions, said apparatus comprising:

a memory for storing data and a computer program;

a processor coupled to said memory for executing said computer program, said computer program comprising instructions for:
segmenting the image into foreground and background regions by comparing a block of the image with a corresponding block in a scene model for the image, said block of the image and the corresponding block being obtained at a predetermined block size;
accumulating foreground activity in the block of the image based on the segmentation;
altering the block size of the image, in an event that the accumulated
foreground activity satisfies a pre-determined threshold; and
determining a further scene model corresponding to the altered block size.

According to still another aspect of the present disclosure, there is provided a computer readable medium comprising a computer program stored thereon segmenting an image into foreground and background regions, said program comprising:

code for segmenting the image into foreground and background regions by comparing a block of the image with a corresponding block in a scene model for the image, said block of the image and the corresponding block being obtained at a predetermined block size;

code for accumulating foreground activity in the block of the image based on the segmentation;

code for altering the block size of the image, in an event that the accumulated foreground activity satisfies a pre-determined threshold; and

code for determining a further scene model corresponding to the altered block size.

Other aspects are also disclosed.

### BRIEF DESCRIPTION OF THE DRAWINGS

Some aspects of the prior art and at least one embodiment of the present invention will now be described with reference to the drawings and appendices, in which:

FIGS. 1 and 2 collectively form a schematic block diagram representation of a camera system upon which described arrangements can be practiced;

FIG. 3a is a block diagram of an input image;

FIG. 3b is a block diagram of a scene model for the input image of FIG. 3a that includes visual element models, each with mode models;

FIG. 4 is a schematic flow diagram showing a method of segmenting an image into foreground and background regions;

FIG. 5a shows an image tessellated into a regular segmentation grid;

FIG. 5b shows an image tessellated into three different sizes of visual elements;

FIG. 6 is a schematic flow diagram showing a method of selecting a matching mode model for a visual element;

FIG. 7a shows a central block having four equally-sized neighbouring candidate mode models;

FIG. 7b shows a block and four neighbouring blocks some of which are larger than the central block;

FIG. 7c shows a central block having a number of neighbouring blocks most of which are smaller than the central block;

FIG. 8a shows an example image;

FIG. 8b shows an example of a scene model corresponding to the image of FIG. 8a;

FIG. 9 is a schematic flow diagram showing a method of determining a scene model for a scene

FIG. 10a shows a foreground activity map determined from a single image at a fixed-size tessellation configuration;

FIG. 10b shows a foreground activity map averaged over a number of images;

FIG. 10c shows a tessellation configuration using four different sizes of blocks;

FIG. 11 is a schematic flow diagram showing a method of determining a tessellation configuration for a scene model based on a foreground activity map;

FIG. 12a shows a section of the foreground activity map of FIG. 10b;

FIG. 12b shows the section of the foreground activity map of FIG. 12b showing different sized tessellation blocks;

FIG. 12c shows the section of the foreground activity map of FIG. 12b following the merging of identified tessellation blocks;

FIG. 13a shows a block of the scene model of FIG. 3, with an associated visual element model;

FIG. 13b shows the block of FIG. 13a split into four blocks;

FIG. 14a shows a set of blocks in a scene model;

FIG. 14b shows a larger block resulting from merging the smaller blocks of FIG. 14a;

FIG. 15 is a schematic flow diagram showing a method of determining whether detection of activity is a false positive;

FIG. 16a shows boundary blocks and detected edge pixels within boundary blocks;

FIG. 16b shows a construct by which contrast may be measured on either side of an edge at a boundary block;

FIG. 16c shows four possible boundary block patterns for which an expected edge orientation may be obtained from the example of FIG. 16a;

FIG. 17a shows an example background representation overlaid with a multi-scale segmentation method;

FIG. 17b shows an example background representation overlaid with an accumulated map of false detections over time;

FIG. 17c shows an example background representation overlaid with a newly modified segmentation method;

FIG. 18a shows an example field of view consisting of two lanes on a road;

FIG. 18b shows the field of view of FIG. 18a at a different point in time;

FIG. 19a shows an example scene model tessellation corresponding to the scene activity in FIG. 18a; and

FIG. 19b shows an example scene model tessellation corresponding to the scene activity in FIG. 18b.

### DETAILED DESCRIPTION

Where reference is made in any one or more of the accompanying drawings to steps and/or features that have the same reference numerals, those steps and/or features have for the purposes of this description the same function(s) or operation(s), unless the contrary intention appears.

A computer-implemented method, system, and computer program product for modifying/updating a scene model is described below. The updated/modified scene model may then be used in processing of a video sequence.

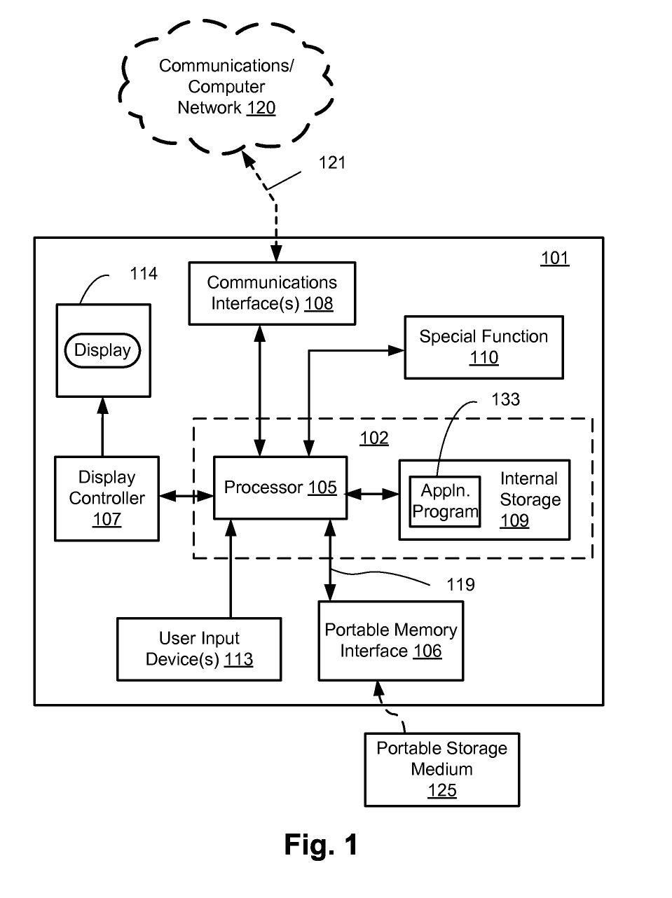

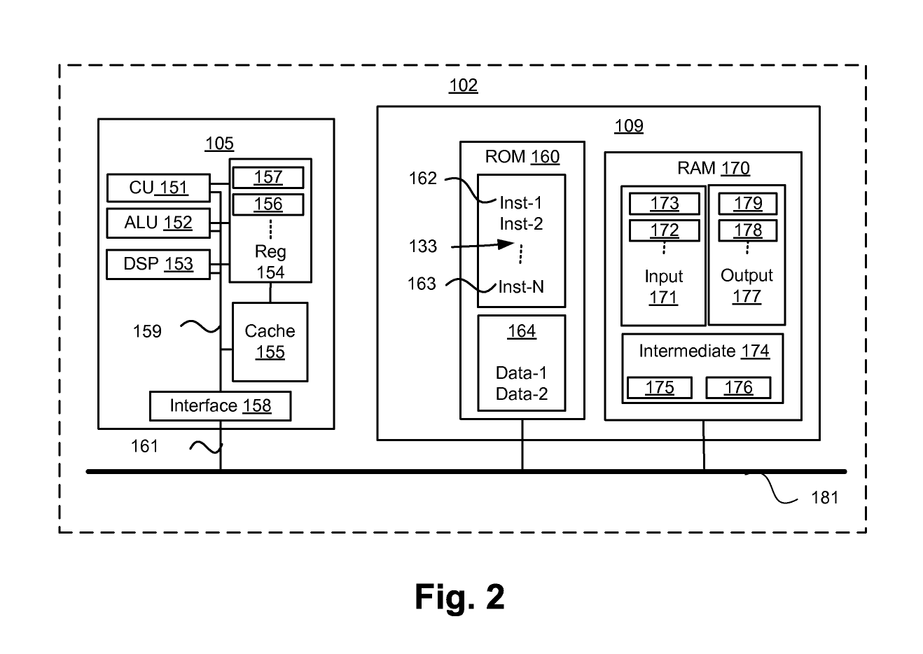

FIGS. 1 and 2 collectively form a schematic block diagram of a camera system 101 including embedded components, upon which foreground/background segmentation methods to be described are desirably practiced. The camera system 101 may be, for example, a digital camera or a mobile phone, in which processing resources are limited. Nevertheless, the methods to be described may also be performed on higher-level devices such as desktop computers, server computers, and other such devices with significantly larger processing resources.

The camera system 101 is used to capture input images representing visual content of a scene appearing in the field of view (FOV) of the camera system 101. Each image captured by the camera system 101 comprises a plurality of visual elements. A visual element is defined as an image sample. In one arrangement, the visual element is a pixel, such as a Red-Green-Blue (RGB) pixel. In another arrangement, each visual element comprises a group of pixels. In yet another arrangement, the visual element is an eight (8) by eight (8) block of transform coefficients, such as Discrete Cosine Transform (DCT) coefficients as acquired by decoding a motion-JPEG frame, or Discrete Wavelet Transformation (DWT) coefficients as used in the JPEG-2000 standard. The colour model is YUV, where the Y component represents luminance, and the U and V components represent chrominance.

As seen in FIG. 1, the camera system 101 comprises an embedded controller 102. In the present example, the controller 102 has a processing unit (or processor) 105 which is bi-directionally coupled to an internal storage module 109. The storage module 109 may be formed from non-volatile semiconductor read only memory (ROM) 160 and semiconductor random access memory (RAM) 170, as seen in FIG. 2. The RAM 170 may be volatile, non-volatile or a combination of volatile and non-volatile memory.

The camera system 101 includes a display controller 107, which is connected to a display 114, such as a liquid crystal display (LCD) panel or the like. The display controller 107 is configured for displaying graphical images on the display 114 in accordance with instructions received from the controller 102, to which the display controller 107 is connected.

The camera system 101 also includes user input devices 113 which are typically formed by a keypad or like controls. In some implementations, the user input devices 113 may include a touch sensitive panel physically associated with the display 114 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 1, the camera system 101 also comprises a portable memory interface 106, which is coupled to the processor 105 via a connection 119. The portable memory interface 106 allows a complementary portable memory device 125 to be coupled to the electronic device 101 to act as a source or destination of data or to supplement the internal storage module 109. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The camera system 101 also has a communications interface 108 to permit coupling of the camera system 101 to a computer or communications network 120 via a connection 121. The connection 121 may be wired or wireless. For example, the connection 121 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

Typically, the controller 102, in conjunction with further special function components 110, is provided to perform the functions of the camera system 101. The components 110 may represent an optical system including a lens, focus control and image sensor. In one arrangement, the sensor is a photo-sensitive sensor array. As another example, the camera system 101 may be a mobile telephone handset. In this instance, the components 110 may also represent those components required for communications in a cellular telephone environment. The special function components 110 may also represent a number of encoders and decoders of a type including Joint Photographic Experts Group (JPEG), (Moving Picture Experts Group) MPEG, MPEG-1 Audio Layer 3 (MP3), and the like.

The methods described below may be implemented using the embedded controller 102, where the processes of FIGS. 2 to 19b may be implemented as one or more software application programs 133 executable within the embedded controller 102. The camera system 101 of FIG. 1 implements the described methods. In particular, with reference to FIG. 1B, the steps of the described methods are effected by instructions in the software 133 that are carried out within the controller 102. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 133 of the embedded controller 102 is typically stored in the non-volatile ROM 160 of the internal storage module 109. The software 133 stored in the ROM 160 can be updated when required from a computer readable medium. The software 133 can be loaded into and executed by the processor 105. In some instances, the processor 105 may execute software instructions that are located in RAM 170. Software instructions may be loaded into the RAM 170 by the processor 105 initiating a copy of one or more code modules from ROM 160 into RAM 170. Alternatively, the software instructions of one or more code modules may be pre-installed in a non-volatile region of RAM 170 by a manufacturer. After one or more code modules have been located in RAM 170, the processor 105 may execute software instructions of the one or more code modules.

The application program 133 is typically pre-installed and stored in the ROM 160 by a manufacturer, prior to distribution of the electronic device 101. However, in some instances, the application programs 133 may be supplied to the user encoded on one or more CD-ROM (not shown) and read via the portable memory interface 106 of FIG. 1A prior to storage in the internal storage module 109 or in the portable memory 125. In another alternative, the software application program 133 may be read by the processor 105 from the network 120, or loaded into the controller 102 or the portable storage medium 125 from other computer readable media. Computer readable storage media refers to any non-transitory tangible storage medium that participates in providing instructions and/or data to the controller 102 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 101. Examples of transitory or non-tangible computer readable transmission media that may also participate in the provision of software, application programs, instructions and/or data to the device 101 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the application programs 133 and the corresponding code modules mentioned above may be executed to implement one or more graphical user interfaces (GUIs) to be rendered or otherwise represented upon the display 114 of FIG. 1. Through manipulation of the user input device 113 (e.g., the keypad), a user of the device 101 and the application programs 133 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 2 illustrates in detail the embedded controller 102 having the processor 105 for executing the application programs 133 and the internal storage 109. The internal storage 109 comprises read only memory (ROM) 160 and random access memory (RAM) 170. The processor 105 is able to execute the application programs 133 stored in one or both of the connected memories 160 and 170. When the electronic device 101 is initially powered up, a system program resident in the ROM 160 is executed. The application program 133 permanently stored in the ROM 160 is sometimes referred to as “firmware”. Execution of the firmware by the processor 105 may fulfil various functions, including processor management, memory management, device management, storage management and user interface.

The processor 105 typically includes a number of functional modules including a control unit (CU) 151, an arithmetic logic unit (ALU) 152 and a local or internal memory comprising a set of registers 154 which typically contain atomic data elements 156, 157, along with internal buffer or cache memory 155. One or more internal buses 159 interconnect these functional modules. The processor 105 typically also has one or more interfaces 158 for communicating with external devices via system bus 181, using a connection 161.

The application program 133 includes a sequence of instructions 162 though 163 that may include conditional branch and loop instructions. The program 133 may also include data, which is used in execution of the program 133. This data may be stored as part of the instruction or in a separate location 164 within the ROM 160 or RAM 170.

In general, the processor 105 is given a set of instructions, which are executed therein. This set of instructions may be organised into blocks, which perform specific tasks or handle specific events that occur in the electronic device 101. Typically, the application program 133 waits for events and subsequently executes the block of code associated with that event. Events may be triggered in response to input from a user, via the user input devices 113 of FIG. 1, as detected by the processor 105. Events may also be triggered in response to other sensors and interfaces in the electronic device 101.

The execution of a set of the instructions may require numeric variables to be read and modified. Such numeric variables are stored in the RAM 170. The disclosed method uses input variables 171 that are stored in known locations 172, 173 in the memory 170. The input variables 171 are processed to produce output variables 177 that are stored in known locations 178, 179 in the memory 170. Intermediate variables 174 may be stored in additional memory locations in locations 175, 176 of the memory 170. Alternatively, some intermediate variables may only exist in the registers 154 of the processor 105.

The execution of a sequence of instructions is achieved in the processor 105 by repeated application of a fetch-execute cycle. The control unit 151 of the processor 105 maintains a register called the program counter, which contains the address in ROM 160 or RAM 170 of the next instruction to be executed. At the start of the fetch execute cycle, the contents of the memory address indexed by the program counter is loaded into the control unit 151. The instruction thus loaded controls the subsequent operation of the processor 105, causing for example, data to be loaded from ROM memory 160 into processor registers 154, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 133, and is performed by repeated execution of a fetch-execute cycle in the processor 105 or similar programmatic operation of other independent processor blocks in the electronic device 101.

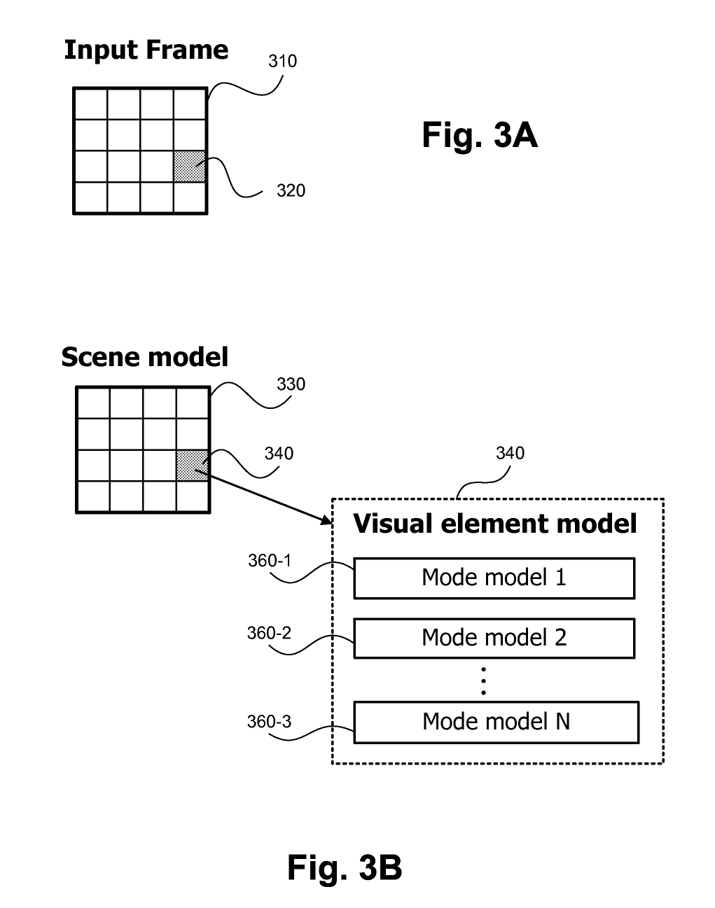

FIG. 3a shows a schematic representation of an input image 310 that includes a plurality of visual elements. A visual element is the elementary unit at which processing takes place and is based on capture by an image sensor 100 of the camera system 101. In one arrangement, a visual element is a pixel. In another arrangement, a visual element is an 8×8 pixel DCT block.

FIG. 3b shows a schematic representation of a scene model 330 for the image 310, where the scene model 330 includes a plurality of visual element models. In the example shown in FIGS. 3a and 3b, the input image 310 includes an example of a visual element 320 and the scene model 330 includes a corresponding example visual element 340. In one arrangement, the scene model 330 is stored in the memory 170 of the camera system 101. In one arrangement, the processing of the image 310 is executed by the controller 102 of the camera system 101. In an alternative arrangement, processing of an input image is performed by instructions executing on a processor of a general purpose computer.

A scene model includes a plurality of visual element models. As seen in FIGS. 3a and 3b, for each input visual element that is modelled, such as the visual element 320, a corresponding visual element model 340 is maintained in the scene model 330. Each visual element model 340 includes a set of one or more mode models 360-1, 360-2 and 360-3. Several mode models may correspond to the same location in the captured input image 310. Each of the mode models 360-1, 360-2, 360-3 are based on history of values for the corresponding visual element 320. The visual element model 340 includes a set of mode models that includes “mode model 1” 360-1, “mode model 2” 360-2, up to “mode model N” 360-3.

Each mode model (e.g., 360-1) corresponds to a different state or appearance of a corresponding visual element (e.g., 340). For example, where a flashing neon light is in the scene being modelled, and mode model 1, 360-1, represents “background—light on”, mode model 2, 360-2, may represent “background—light off”, and mode model N, 360-3, may represent a temporary foreground element such as part of a passing car.

In one arrangement, a mode model represents mean value of pixel intensity values. In another arrangement, the mode model represents median or approximated median of observed DCT coefficient values for each DCT coefficient, and the mode model records temporal characteristics (e.g., age of the mode model). The age of the mode model refers to how long since the mode model was generated.

If the description of an incoming visual element is similar to one of the mode models, then temporal information about the mode model, such as the age of the mode model, may be used to produce information about the scene. For example, if an incoming visual element has the same description as a very old visual element mode model, then the visual element location may be considered to be established background. If an incoming visual element has the same description as a young visual element mode model, then the visual element location may be considered to represent at least a portion of a background region or a foreground region depending on a threshold value. If the description of the incoming element does not match any known mode model, then the visual information at the mode model location has changed and the mode model location may be considered to be a foreground region.

In one arrangement, there may be one matched mode model in each visual element model. That is, there may be one mode model matched to a new, incoming visual element. In another arrangement, multiple mode models may be matched at the same time by the same visual element. In one arrangement, at least one mode model matches a visual element model. In another arrangement, it is possible for no mode model to be matched in a visual element model.

In one arrangement, a visual element may only be matched to the mode models in a corresponding visual element model. In another arrangement, a visual element is matched to a mode model in a neighbouring visual element model. In yet another arrangement, there may be visual element models representing a plurality of visual elements and a mode model in that visual element mode model may be matched to any one of the plurality of visual elements, or to a plurality of those visual elements.

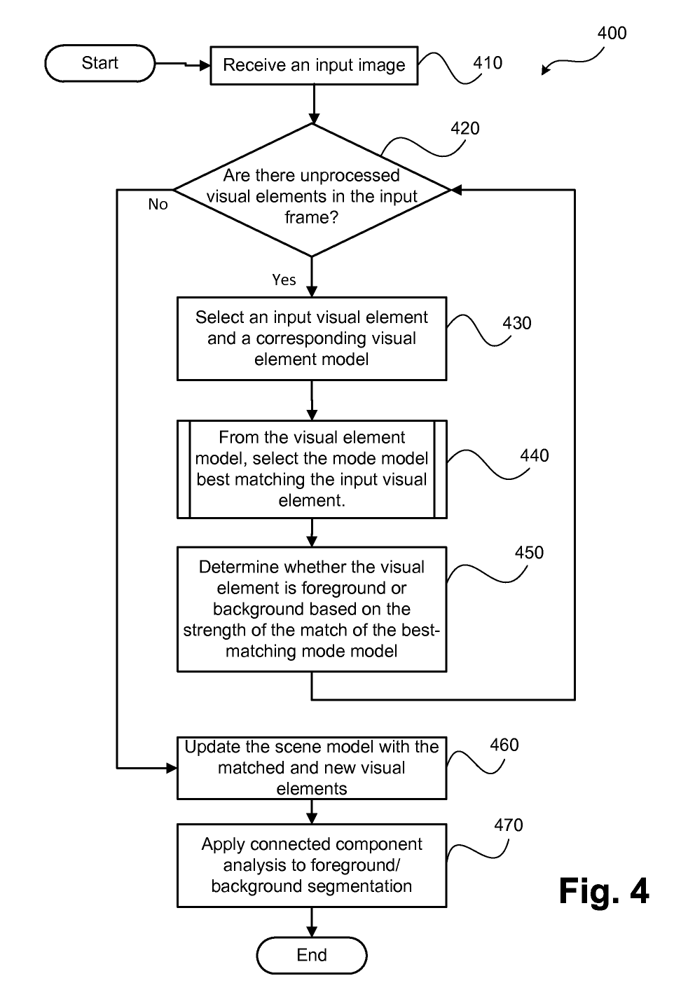

FIG. 4 is a flow diagram showing a method 400 of segmenting an image into foreground and background regions. The method 400 may be implemented as one or more code modules of the software application program 133 resident in the ROM 160 and be controlled in its execution by the controller 102 as previously described.

The method 400 will be described by way of example with reference to the input image 310 and the scene model 330 of FIGS. 3a and 3b.

The method 400 begins at a receiving step 410, where the controller 102 receives the input image 310. The input image 310 may be stored in the RAM 170 by the controller 102. Control passes to a decision step 420, where if the controller 102 determines that any visual elements 320 of the input image 310, such as pixels or pixel blocks, are yet to be processed, then control passes from step 420 to selecting step 430. Otherwise, the method 400 proceeds to step 460.

At selecting step 430, the controller 102 selects a visual element (e.g., 320) for further processing and identifies a corresponding visual element model (e.g., 340).

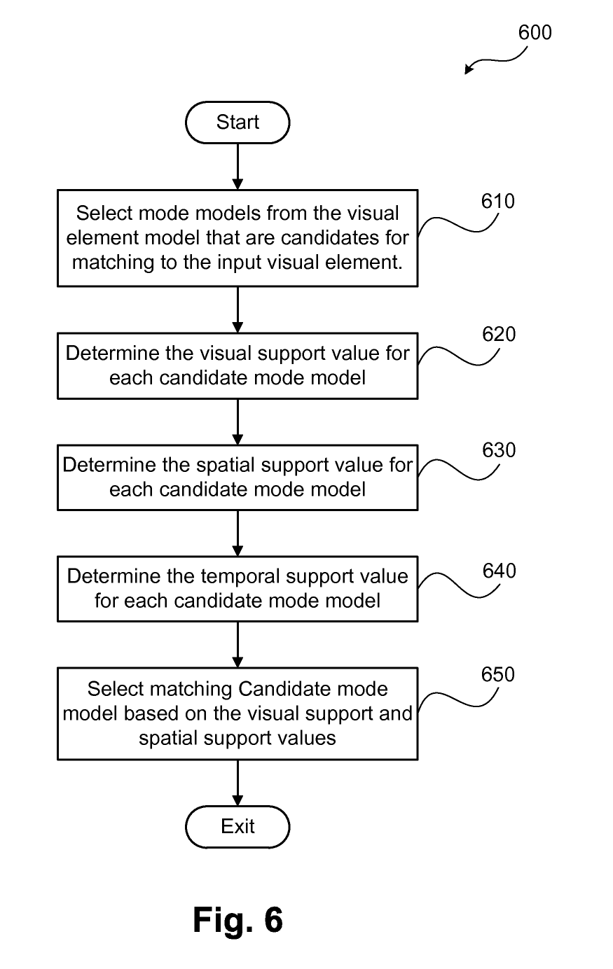

Control then passes to selecting step 440, in which the controller 102 performs the step of comparing the visual element 320 from the input image 310 against the mode models in the visual element model corresponding to the visual element that is being processed, in order to select a closest-matching mode model and to determine whether the visual element 320 is a “foreground region” or a “background region” as described below. Again the visual element model may be stored in the RAM 170 by the controller 102. The closest-matching mode model may be referred to as the matched mode model. A method 600 of selecting a matching mode model for a visual element, as executed at step 440, will be described in detail below with reference to FIG. 6.

Control then passes from step 440 to classifying step 450, where the controller 102 classifies the visual element that is being processed as “foreground” or “background”. A visual element classified as foreground represents at least a portion of a “foreground region”. Further, a visual element classified as background represents at least a portion of a “background region”.

The classification is made at step 450 based on the properties of the mode model and further based on a match between the visual element selected at step 430 and the mode model selected at step 440. Next, control passes from classifying step 450 and returns to decision step 420 where the controller 102 determines whether there are any more visual elements to be processed. As described above, if at decision step 420 there are no more visual elements in the input image 310 to be processed, then the segmentation method is complete at the visual element level and control passes from step 420 to updating step 460. After processing all the visual elements, at step 460, the controller 102 updates the scene model 330 according to the determined matched mode model for each visual element (e.g., 340). In one arrangement, at the updating step 460, the controller 102 stores the updated scene model 330 in the RAM 170.

Control passes from step 460 to post-processing step 470, where the controller 102 performs post-processing on the updated scene model. In one arrangement, connected component analysis is performed on the updated scene model (i.e., the segmentation results) at step 470. For example, the controller 102 may perform flood fill on the updated scene model at step 470. In another arrangement, the post-processing performed at step 470 may comprise removing small connected components, and morphological filtering of the updated scene model.

After step 470, the method 400 concludes with respect to the input image 310. The method 400 may optionally be repeated for other images. As described above, in step 440 the controller 102 selects a closest-matching mode model. There are multiple methods for selecting a matching mode model for a visual element of the input image.

In one arrangement, the controller 102 compares an input visual element (e.g., 320) to each of the mode models in the visual element model corresponding to that input visual element. The controller 102 then selects the mode model with the highest similarity as a matching mode model.

In another arrangement, the controller 102 utilises a threshold value to determine if a match between an input visual element and a mode model is an acceptable match. In this instance, there is no need to compare further mode models once a match satisfies the threshold. For example, a mode model match may be determined if the input value is within 2.5 standard deviations of the mean of the mode model. Such a threshold value arrangement is useful in an implementation in which computing a similarity is an expensive operation.

In still another alternative arrangement, in determining a match between an input visual element and a mode model the controller 102 may be configured to utilise more than one match criterion to obtain more than one type of match. In this instance, the controller 102 may then utilise the match type to determine a later process or mode model for a process to act upon. For example, the controller 102 may be configured to perform separate matches for an intensity pattern match, and for an overall brightness match.

One aspect of the present disclosure is determining the similarity between the input visual element (e.g., 320) and a mode model (e.g., 360-1). For some scene models (also known as background models), such as a mean intensity representation, the determination of similarity between the input visual element and a mode model is less complex than for more complex scene models. For example, when the visual element is an 8×8 block with DCT coefficients, similarity needs to be defined over multiple variables. In one arrangement, machine learning methods may be used to map multi-dimensional input values to one probability value, indicating the probability that a mode model matches the input visual element. Such machine learning methods may include, for example, Support Vector Machines and Naïve Bayes classifiers.

The selection of a matching mode model based purely on the information in the visual element is sensitive to noise in the input signal. The sensitivity to noise may be reduced by taking into account context, such as by considering spatially neighbouring visual elements. Object detection may be performed to find objects that are sufficiently visible to span multiple visual elements. Therefore, when one visual element is found to be foreground, it is reasonable to expect that there are other foreground visual elements in the neighbourhood of that visual element. If there are no foreground visual elements in the neighbourhood of that visual element, it is possible that the visual element should not be determined to be foreground.

Visual elements that are part of the same object are not necessarily visually similar. However, visual elements that are part of the same object are likely to have similar temporal characteristics. For example, if an object is moving, all visual elements associated with that object will have been visible only for a short period. In contrast, if the object is stationary, all visual elements will have been modelled for a similar, longer period of time.

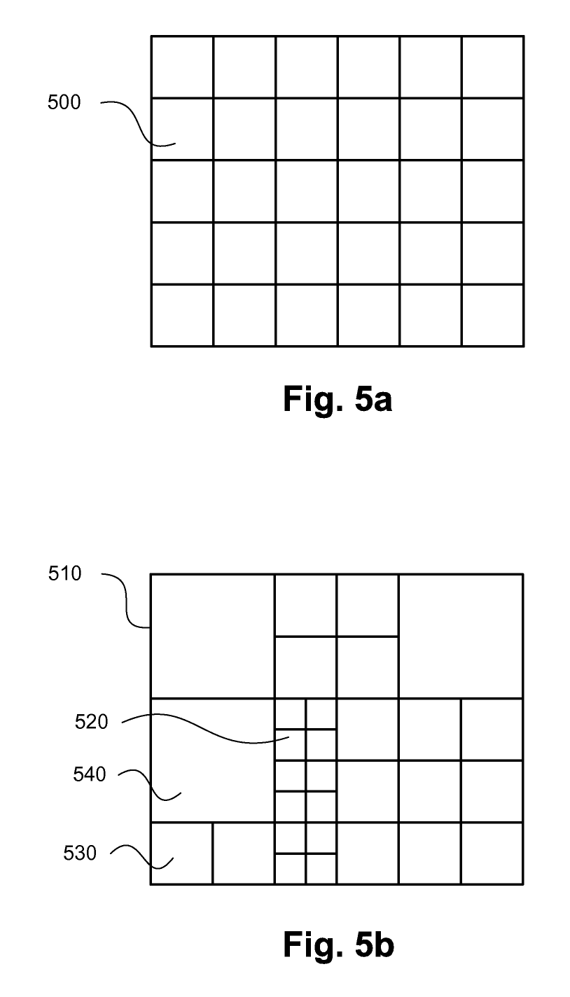

FIG. 5a shows an image 500 tessellated into a regular segmentation grid comprising a plurality of regions. In one arrangement, the scene model 330 may be represented using a hybrid-resolution tessellation configuration. That is, different regions of a field of view (FOV) of an image may be modelled using different sizes of visual elements. As an example, FIG. 5b shows an example of an image 510 tessellated into three different sizes of visual elements for the field of view of the image 510. As seen in FIG. 5b, some visual elements 520 are small, some visual elements 530 have a medium size, and some visual elements 530 are large. As an example, small elements 520 may comprise 8×8-pixel blocks, medium elements 530 comprise 16×16 pixel-blocks, and large elements 540 comprise 32×32-pixel blocks. The use of different visual element sizes in the field of view (FOV) of an image is termed as hybrid-resolution.

In one arrangement, each visual element of a tessellated image is square as shown in FIG. 5b. In another arrangement, each visual element of the tessellated image is rectangular. In yet another arrangement, each visual element of the tessellated image is triangular.

In one arrangement, the sizes of the visual elements of a tessellated image may be related. For example, the width of the visual element 530 may be an even multiple of the width of the visual element 520. In another arrangement, the size of the sides of the visual elements (e.g., 520, 530, 540) may be integer powers of two of each other. In yet another arrangement, each of the visual elements (e.g., 520, 530, 540) may have arbitrary sizes.

In one arrangement, each of the different sizes of visual elements (e.g., 520, 530, 540) store the same amount of information. In one arrangement, the information stored in each of the visual elements may be a fixed number of frequency domain coefficients (e.g., the first six (6) DCT coefficients, from a 2-dimensional DCT performed on each pixel block). In another arrangement, the number of frequency domain coefficients in each visual element may be dependent on the size of the visual elements, where a larger number of coefficients may be stored for larger visual elements. For example, the number of coefficients may be proportional to the relative sizes of the visual elements using a baseline of six (6) coefficients for an 8×8-pixel block. A 16×8 pixel block may have twelve (12) coefficients.

In one arrangement, the configuration of the tessellation of an input image (e.g., 310) is determined based on a computational budget depending on the specifications of the controller 102. In one arrangement, any choice of the two tessellation configurations in FIG. 5a and FIG. 5b is computationally equivalent because the tessellated images 500 and 510 have the same number of blocks of pixels (i.e., each tessellated image 500 and 510 contains thirty (30) blocks of pixels), as the number of blocks of pixels is related to the computational cost of using the model. In another arrangement, the number of coefficients modelled in the scene model (e.g., 330) may have a maximum (e.g., one thousand (1000) coefficients). For example, a scene model (e.g., 330) having fifty (50) visual elements each having five (5) mode models, with each mode model having four (4) coefficients, may be acceptable within such a maximum. Further, a scene model having one-hundred (100) visual elements with each visual element having two (2) mode models, where each mode model has five (5) coefficients, may also be acceptable within the maximum.

In another arrangement, the configuration of the tessellated input image may be determined based on a memory budget depending on the specifications of the RAM 170, in a similar manner to the computational budget.

In step 440, the visual features of the visual element are matched with the visual features of the mode models. In one arrangement, the visual features being matched are eight (8) DCT features generated from the YUV color space values of sixty-four (64) pixels in an 8×8 pixel block using a two-dimensional (2D) DCT transform. The eight (8) DCT features selected may be the first six (6) luminance channel coefficients Y0, Y1, Y2, Y3, Y4, Y5, and the first coefficients of the two chroma channels, U0 and V0.

In one arrangement, for visual elements of sizes different than 8×8 pixels, such as 4×4 pixels and 16×16 pixels, the same eight (8) DCT features (Y0, Y1, Y2, Y3, Y4, Y5, U0 and V0) are used at step 440 to match the visual element with the mode model. The visual features may be generated using a two dimensional (2D) DCT transform using sixteen (16) pixel YUV values in case of the visual element being a 4×4 pixel block. Similarly, the visual features may be generated using a two dimensional (2D) DCT transform using two hundred and fifty six (256) pixel YUV values in case of the visual element being a 16×16 pixel block.

In video foreground segmentation using different pixel block sizes (e.g., 4×4, 8×8, 16×16 pixel blocks) for visual elements and using the same number of visual features (e.g., 8 DCT features) for each element, the foreground precision decreases as block sizes increase.

FIG. 6 is a flow diagram showing a method 600 of selecting a matching mode model for a visual element, as executed at step 440. The method 600 may be implemented as one or more code modules of the software application program 133 resident in the ROM 160 and being controlled in its execution by the controller 102.

The method 600 will be described by way of example with reference to the input image 310 and the scene model 330 of FIGS. 3a and 3b.

The method 600 begins at selecting step 610, where the controller 102 performs the step of selecting mode models (e.g., 360-1, 360-2, 360-3), from a visual element model (e.g., 340, 350), corresponding to the visual element 320, as candidates for matching to the input visual element 320. The selected candidate mode models may be stored within the RAM 170 by the controller 102.

Next, control passes to step 620, where the controller 102 performs the step of determining a visual support value for each candidate mode model. The visual support value determined at step 620 is based on the similarity of the visual information stored in each candidate mode model to the visual information in the incoming visual element 320. In one arrangement, the visual support value represents probability of matching the mode model (e.g., 360-1 to the visual element (e.g., 340). In another arrangement, the visual support value may be an integer representing the amount of variation between the visual information stored in each candidate mode model to the visual information in the incoming visual element 320.

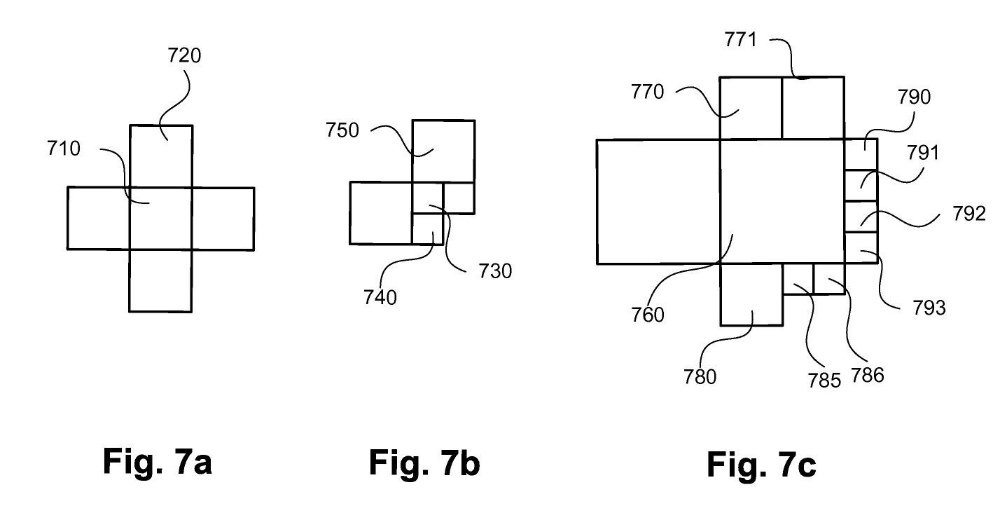

Control then passes from step 620 to spatial support determining step 630, where the controller 102 determines a spatial support value for each candidate mode model. In one arrangement, at step 620, the controller 102 determines how many mode models neighbouring a candidate mode model have a similar creation time to the candidate mode model. The controller 102 then determines how many of the mode models having a similar creation time are currently matched to the background. In this instance, the spatial support value for a candidate mode model represents a count of the neighbouring mode models having a similar creation time to the candidate mode model, as will be described in further detail below with reference to FIGS. 7a, 7b and 7c. The controller 102 may store the determined spatial support values in the RAM 170.

Control then passes to temporal support determining step 640, where the controller 102 determines a temporal support value for each candidate mode model. In one arrangement, the temporal support value represents a count of the number of times in the last N images (e.g., thirty (30) images) in a sequence of images, that the mode model has been matched to a visual element. In another arrangement, the temporal support value may be set to a value (e.g., one (1)), if the mode model has been matched more than a predetermined number of times (e.g., five (5) times), otherwise, the temporal support value is set to another value (e.g., zero (0)). The controller 102 may store the determined temporal support values in the RAM 170.

Control then passes to matching step 650, where the controller 102 selects a matching mode model from the candidate mode models selected at step 610. For each candidate mode model, the spatial support value, visual support value, and temporal support value are combined by the controller 102 to determine a mode model matching score. In one arrangement, the mode model matching score is determined for a candidate mode model by adding the spatial support value, visual support value, and temporal support value together after applying a weighting function to each value in accordance with Equation (1), as follows:

Mode_model_matching_score=wᵥ·Visual_Support+wₛ·Spatial_Support+wₜ·Temporal_Support (1)

where weight values wᵥ, wₛ, and wₜ are predetermined.

In one arrangement, the mode model matching score is determined for each candidate mode model, and the candidate mode model with the highest mode model matching score is selected as the matching mode model corresponding to the input visual element 320.

In another arrangement, a mode model matching threshold value (e.g., four (4)), is used. The mode model matching score may be determined for candidate mode models in order until a mode model matching score exceeds the mode model matching value threshold.

The processing of a visual element terminates following step 650. Any number of other visual elements may be processed in a similar fashion.

FIGS. 7a, 7b and 7c show how spatial support values are determined for a candidate mode model as at step 630.

FIG. 7a shows a central block 710 and equally-sized neighbouring blocks (e.g., 720). The spatial support value may be determined based on how many of the four neighbouring blocks (e.g., 720) match the background.

FIG. 7b shows a central block 730, at least one neighbouring block 740 of the same size, and at least one neighbouring block 750 of a larger size. Since neighbouring blocks of the same or larger sizes correspond to edges of the block 730, the same method may be used at step 650 for determining the spatial support value as was used in FIG. 7a. That is, the spatial support value may be determined based on how many of the four neighbouring blocks (e.g., 740, 750) match the background. In the example of FIG. 7a, the spatial support value is independent of size of mode models in block 720 neighbouring the block 710 to be segmented, if the block 720 is larger than or equal to the block 710 to be segmented. Similarly, in the example of FIG. 7b, the spatial support value is independent of size of mode models in blocks 740 and 750 neighbouring the block 730 to be segmented, if the blocks 740 and 750 are larger than or equal to the block 730 to be segmented.

FIG. 7c shows a central block 760 having neighbouring blocks of different sizes. One edge of the block 760 has two neighbouring blocks 770 and 771 of only half the size of the block 760. Another edge of the block 760 has three neighbouring blocks 780, 785 and 786. The block 780 is of half the size of the block 760. The other two blocks 785 and 786 are at a quarter of the size of the block 760. Yet another edge of the candidate block 760 has four neighbouring blocks 790, 791 792 and 793 each being of one quarter of the size of the central block 760. In the example of FIG. 7c, the spatial support value is dependent on size of mode models in blocks (e.g., 780, 770 and 790) neighbouring a block 760 to be segmented if the blocks (i.e., 780, 770 and 790) neighbouring the block 760 to be segmented is smaller than the block 760 to be segmented.

For the example of FIG. 7c, in one arrangement, all of the background neighbouring blocks are counted to determine a count value, and the count value is divided by the total number of neighbouring blocks that a block has. The spatial support value for the central block 760 is calculated based on the proportion of neighbouring blocks (e.g., 780, 770, 790) reporting to be matched to background.

In another arrangement, the spatial support score for the example of FIG. 7c is determined by determining the contribution of each edge of the central block 760 separately and summing up the edge contributions to obtain the final count value. In one arrangement, an edge contribution is determined by estimating the proportion of edge which has neighbouring blocks reporting to be matched to background. For example to determine the edge contribution for right edge of the central block 760, block 790, 791,792 and 793 are considered. If block 790 and 791 are reported to be matched to background, then the right edge contribution is 2/4=0.5 to the final count.

In still another arrangement, the final score may be determined by summing the roundup edge contributions where edge contributions are determined by estimating the proportion of edge which has neighbouring blocks reporting to be matched to background

In still another arrangement, the edge contribution for a particular edge of the block 760 of FIG. 7c is determined to be matching the background (i.e. an edge contribution of 1) if at least one neighbouring candidate mode model along that particular edge matches the background.

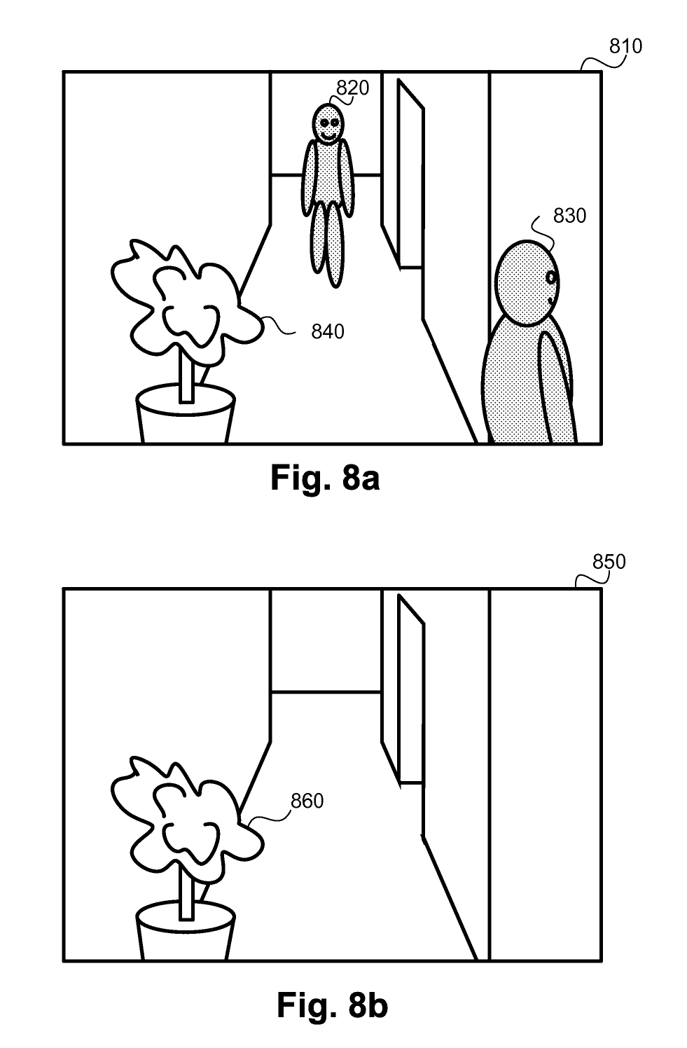

FIG. 8a shows an example image 810 of an image sequence showing a corridor intersection inside a building 810. A person 820 is walking towards the camera system 101 from a medium distance. Another person 830 is walking to the side and away from the camera system 100 to a side corridor. A potted plant 840 which might shake or move as people move past it is also in view of the camera system 101. FIG. 8b shows the appearance of a scene model 850 for the scene shown in the image 810. Moving elements such as the two people 820 and 830 are not present because the people 820 and 830 were only transient elements of the scene shown in the image 810. A representation 860 of the potted plant 840 is visible within the scene model 850 despite the fact that the plant moves, showing an average appearance, because the potted plant 840 never leaves the scene shown in the image 810.

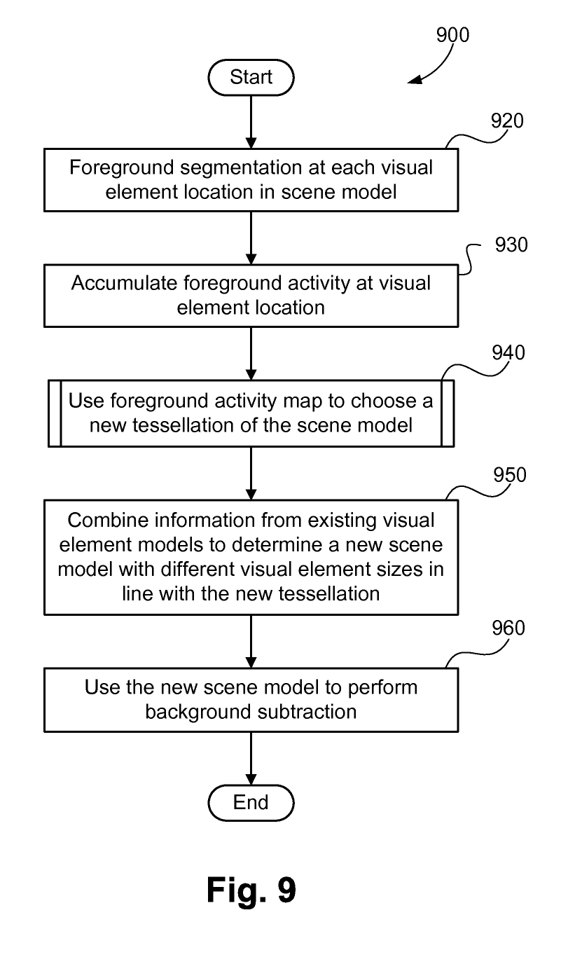

FIG. 9 is a flow chart showing a method 900 of determining a scene model for a scene. The method 900 may be implemented as one or more code modules of the software application program 133 resident in the ROM 160 and being controlled in its execution by the controller 102. The method 900 will be described by way of example with reference to the image 810 of the scene shown in FIG. 8a.

In the method 900, a foreground activity map of the scene is determined. The foreground activity map may be used to form a new tessellation configuration of the scene model determined for the scene. The new tessellation configuration of the scene model may then be used in later processing of images of the scene for foreground segmentation. The foreground activity of the scene is defined based on the number of detected foreground objects in the scene. If the number of detected foreground objects is large, foreground activity should be high. If the number of detected foreground objects is small, foreground activity should be low.

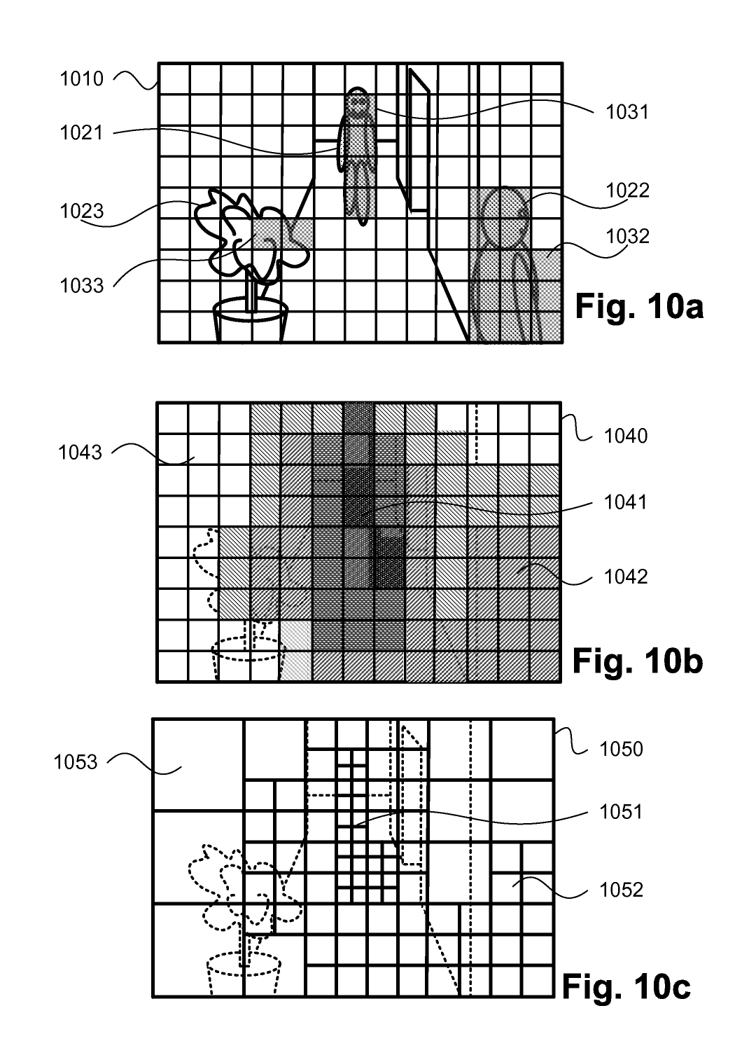

The method 900 begins at determination step 920, where the controller 102 processes images of (e.g., image 810) the scene at a predetermined resolution tessellation configuration, to determine one or more foreground activity maps. FIG. 10a shows an example foreground activity map 1010 for the image 810. In one arrangement, the tessellation configuration used at step 920 may be 96×72 blocks.

In one arrangement, the scene modelling method 400 of FIG. 4 may be used to determine the foreground activity maps (e.g., 810) at step 920. In particular, the controller 102 may perform foreground segmentation at each visual element location in an image of the scene (e.g., image 310) to form the scene model (e.g., 330) for the scene. As described above, the scene model includes a plurality of visual element models. Each visual element model includes a set of one or more mode models. The foreground activity maps and scene model may be stored by the controller 102 within the RAM 170.

Control then passes to accumulation step 930, where the controller 102 accumulates the detected foreground activity represented by the foreground activity maps into a single foreground activity map 1040 as shown in FIG. 10b. As described below, the foreground activity may be accumulated based on a number of images. The foreground activity map 1040 determined at step 930 may be stored within the RAM 170 by the controller 102.

In one arrangement, a fixed number of images (e.g., three thousand (3000) images) are processed at steps 920 and 930. The foreground activity map may be updated every time a number of images (e.g. 3000 images) are captured.

In another arrangement, the number of images to be processed at steps 920 and 930 to accumulate the foreground activity may be determined in an event that accumulated foreground activity satisfies a predetermined level of activity. For example, the number of images to be processed at steps 920 and 930 (i.e., the number of images processed at steps 920 and 930 to accumulate the foreground activity) may be determined based on a minimum level of activity in a given percentage of blocks (e.g., 20% of the blocks of an image of the scene have recorded activity in at least thirty (30) frames), or a relative amount of activity (e.g., 20% of the blocks of an image of the scene have recorded an activity level of at least 10%).

In yet another arrangement, as many images are processed at steps 920 and 930 as are required for at least one block of an image of the scene to record a certain level of activity (e.g., 10%). In yet another arrangement, the number of images processed at steps 920 and 930 may be determined by a user. For example, the number of images may be selected such that the foreground activity map 1040 is a good representation of average foreground activity in the scene.

In yet another arrangement, the number of images processed at steps 920 and 930 to accumulate the foreground activity may be determined based on the difference between first previously accumulated foreground activity and second previously accumulated foreground activity. In this instance, a first foreground activity map, corresponding to the first previously accumulated foreground activity, may be generated based on a pre-determined number of captured images (e.g. 300 images). A second foreground activity map, corresponding to the second previously accumulated foreground activity, is generated based on a next set of the same pre-determined number of captured images. Every time a new foreground activity map is generated, the new foreground map (e.g. second foreground activity map) and a current foreground activity map (e.g. first foreground activity map) are compared to each other using an image comparison method (e.g. average Sum of Absolute Difference). A pre-determined set threshold (e.g. twenty (20) blocks) may be used to determine if the two foreground activity maps are different to each other or not. If the activity maps are not different, then the number of images selected is appropriate. If the activity maps are different (i.e. the average Sum of Absolute Difference is higher than the threshold), the number of images to be used is increased by a small amount (e.g. forty (40) images). The next foreground activity map is generated based on the new total number of frames (e.g. three hundred and forty (340) images). By generating and updating a proper foreground map at step 930 as described above, a proper hybrid-resolution tessellation configuration may be generated at step 940 as described below.

The foreground activity map 1040 represents variation of foreground activity in the Field of View (FOV) of the image 810 shown in FIG. 8a. In one arrangement, the foreground activity map is an array of values, where a small value (e.g., zero (0)) at one location represents no foreground activity, while a high number (e.g., fifty (50)) at a location in the foreground activity map represents higher chances of seeing foreground in that region. In another arrangement, the foreground activity map is a fractional representation, where no activity is represented as 0%, and the most activity detected in the scene is represented as 100%.

In one arrangement, at the accumulation step 930, the controller 102 sums the activity detected in the individual images over time. In another arrangement, at the accumulation step 930, the controller 102 performs a logical operation (e.g., AND) on the individual activity detections to form a binary map indicating the presence or absence of activity within the collection of images processed. In yet another arrangement, at the accumulation step 930, the controller 102 first sums the activity at each block and then applies a nonlinear scaling function (e.g., a logarithm), to form a foreground activity map. The level of activity of the foreground activity map may be medium (e.g., 50%) when a small amount of activity is detected (e.g., five (5) images in five hundred (500) images of a sequence of images), even in the presence of another area having proportionally very high activity (e.g., four hundred and fifty (450) images in five hundred (500) images). In another arrangement, the binary map may be generated using the Histogram Equalization method.

In one arrangement, if the level of measured activity is uniform across the image, steps 940 and 950 may be skipped, and the scene model formed in step 920 for the image may be used as a new scene model in step 960. Steps 940 and 950 may only be performed in the presence of a non-uniform foreground activity.

In another arrangement, sizes of the visual element model blocks used in step 920 may not be the same as the sizes of visual element model blocks to be used in step 960, and the intermediate steps 940 and 950 may be performed. The scene model determined at step 920 may have an approximate initialisation, and be updated over time, so that the camera system 101 does not need to be reset and may keep running.

In another arrangement, the sizes of the visual element model blocks used in step 920 may not be the same as the sizes of the visual element model blocks to be used in step 960, and the intermediate step 940 may be performed. A new scene model may be created at step 940 so that the camera system 101 is reset, and the scene model is initialised. The scene model may be initialised for ten (10) images or five (5) seconds, by observing the scene of FIG. 8a without foreground objects.

In one arrangement, instead of foreground detections being used in step 920 in order to accumulate a foreground activity map in step 930, a stillness measure may be used. Such a stillness measure corresponds to the similarity of each visual element in each image of an image sequence to the corresponding visual element in a previous image of the image sequence. Accordingly, the controller 102 may be configured to determine if a visual element in an image satisfies the stillness measure. In another arrangement, an activity measure is introduced as the basis for the activity map in step 930, where the activity measure is based on total variation in colour over the images used for accumulation.

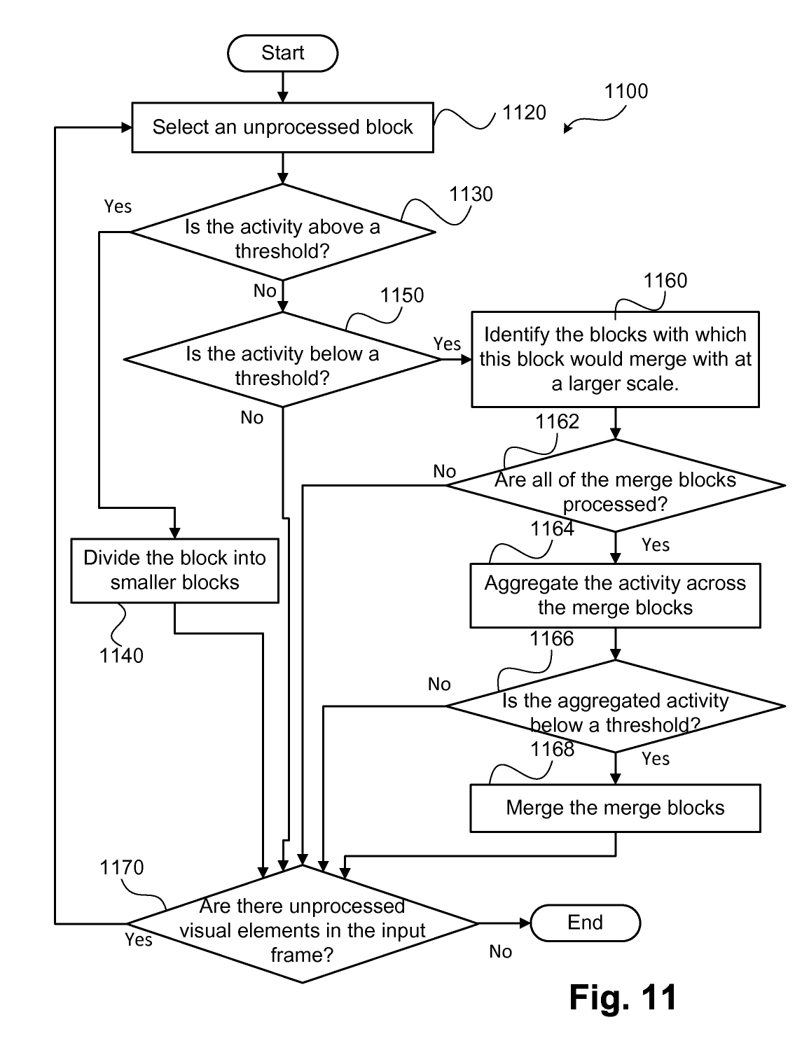

Following step 930, control then passes to the processing step 940. At step 940, the controller 102 uses the foreground activity map determined at step 930 to alter a size of each block (i.e., determine a hybrid-resolution tessellation configuration). The hybrid-resolution tessellation configuration is determined over the field of view (FOV) of the scene. A method 1100 of determining a tessellation configuration for a scene model, as executed at step 940, will be described in detail below with reference to FIG. 11.

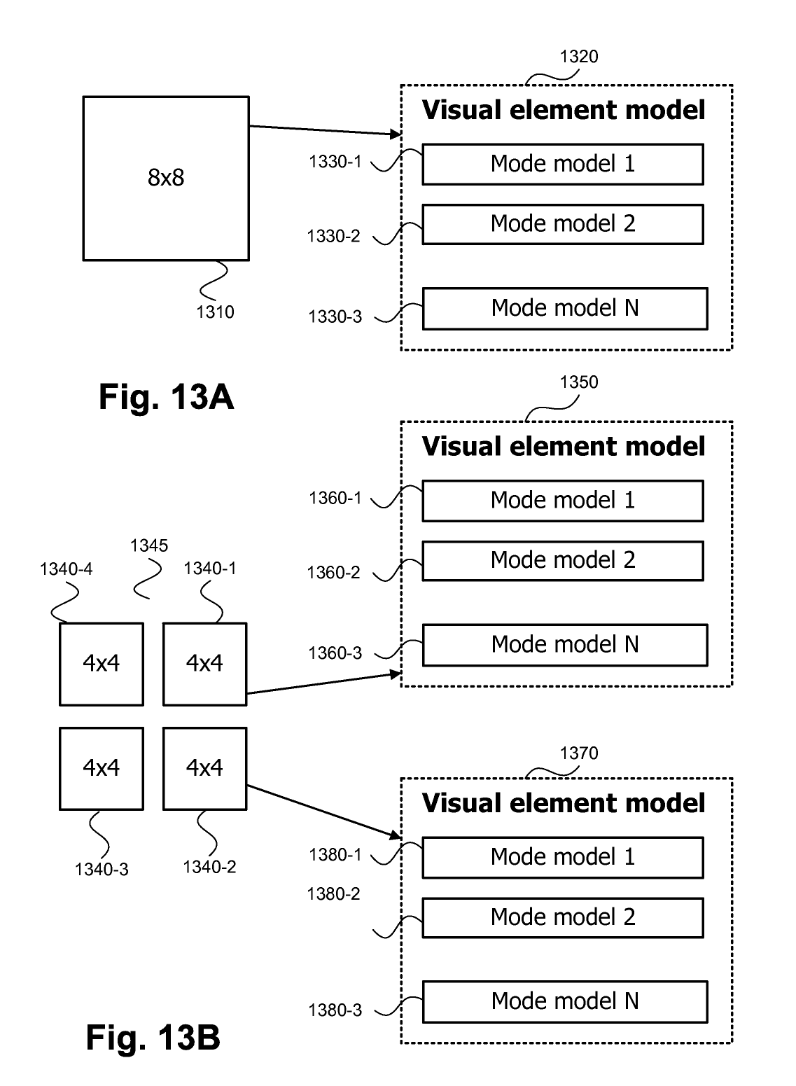

Control then passes to combining step 950, where the controller 102 determines a new hybrid-resolution scene model using mode models determined in processing step 920 and the tessellation configuration determined in processing step 940. The scene model determined at step 950 corresponds to a size of each block. A method 1300 of determining a new hybrid-resolution scene model, as executed at step 950, will now be described with reference to FIG. 13. The hybrid-resolution scene model determined at step 650 is used to process the remaining images of the scene model. FIG. 10a shows an example foreground activity map 1010 formed from a single image (i.e., image 810) of a video of the scene of FIG. 8a. The map 1010 is segmented into blocks for use in performing an initial activity analysis, where blocks where activity has been detected are highlighted. The activity map 1010 represents the field of view (FOV) of the camera system 101. The activity map 1010 shows a foreground object (representing the person 820 of FIG. 8a) in the scene, where highlighted blocks (e.g., 1031) corresponding to the object 1021 represent detected activity (or detected foreground regions). The detected activity for the object 1021 may be determined using the method 400 of segmenting an image described above. Similarly, the activity map 1010 comprises a second object (i.e., representing the second person 830) 1022. Blocks (e.g., 1032) corresponding to the object 1022 are highlighted to represent detected activity for the object 1022. Also shown in FIG. 10a is object 1023 (i.e., representing a potted plant 840), where highlighted blocks (e.g., 1033) represent detected activity for the object 1023 resulting from motion of the plant 840. In one arrangement, the foreground activity map 1010 of FIG. 10a is initialised with default 8×8 pixel blocks for all visual elements in the field of view.

FIG. 10b shows a foreground activity map 1040 averaged over a number of images of the scene corresponding to the map of FIG. 10a. The map 1040 is an example of a background representation of the image of FIG. 10a. In particular, the map 1010 of FIG. 10a is overlaid with an accumulated map of foreground activity detections (or “foreground regions”) over time to form the map 1040. Some parts of the map 1040, such as block 1043, show no detected activity. Other parts of the map 1040, such as block 1042, show a medium level of detected activity. Further, other parts of the map 1040, such as the block 1041, show a high level of detected activity.

FIG. 10c shows the background representation of FIG. 10b overlaid with a new tessellation configuration corresponding to the levels of activity as measured in FIG. 10b. The size of each visual element in the tessellation configuration of FIG. 10c is determined using the foreground activity map 1040 as shown in FIG. 10b. The higher the amount of detected activity in a visual element region (i.e., as shown by darker shade), the denser the foreground activity is in that region. Visual element regions having detected activity represent at least a portion of a foreground region. For example, the block 1041 in FIG. 10b shows an area of high activity, and correspondingly there is a region 1051 in FIG. 10c where small blocks are used for the tessellation. The region 1051 is a foreground region. Similarly, the block 1042 representing medium activity results in no change to the block sizes 1052 in the tessellation configuration of FIG. 10c. Further, areas of sparse or no activity as represented by the blocks 1043 result in large block sizes being used (e.g., block 1053) in the tessellation configuration of FIG. 10c.

The method 1100 of determining a tessellation configuration for a scene model, as executed at step 940, will be described in detail below with reference to FIG. 11. The method 900 may be implemented as one or more code modules of the software application program 133 resident in the ROM 160 and being controlled in its execution by the controller 102.

The method 1100 converts an existing tessellation configuration into a new tessellation configuration using foreground activity measured at each tessellation block. The method 1100 may be used to convert the foreground activity map 1040 with a regular tessellation as shown in FIG. 10b to a hybrid-resolution tessellation as shown in FIG. 10c. It is not a requirement of the method 1100 that the initial tessellation and activity map are regular. In one arrangement, the initial activity map and tessellation have a hybrid resolution and the method 1100 is used to convert the tessellation of the activity map to a different hybrid resolution tessellation.

The method 1100 begins at selection step 1120, where the controller 102 selects an unprocessed tessellation block of an initial tessellation. The unprocessed tessellation block may be stored by the controller 102 within the RAM 170.

The foreground activity at the selected tessellation block is examined at examination step 1130 and if the controller 102 determines that the activity is greater than a predefined threshold, Yes, then the method 1100 proceeds to division step 1140. At step 1140, the controller 102 divides the selected tessellation block into smaller blocks.

Control then passes to completeness confirmation step 1170, where the controller 102 determines whether any unprocessed tessellation blocks remain in the initial tessellation map. If no unprocessed tessellation blocks remain in the initial tessellation map, No, then the method 1100 concludes. Otherwise, if there are unprocessed tessellation blocks remaining, Yes, then control returns to the selection of a new unprocessed tessellation block at step 1120.

If at decision step 1130, the controller 102 determines that the activity is not above (or lower than) a threshold, No, then control passes to a second decision step 1150. At second decision step 1150, if the controller 102 determines that foreground activity is not below (or higher than) a second threshold, then the selected block requires no action, and control passes to completeness confirmation step 1170.

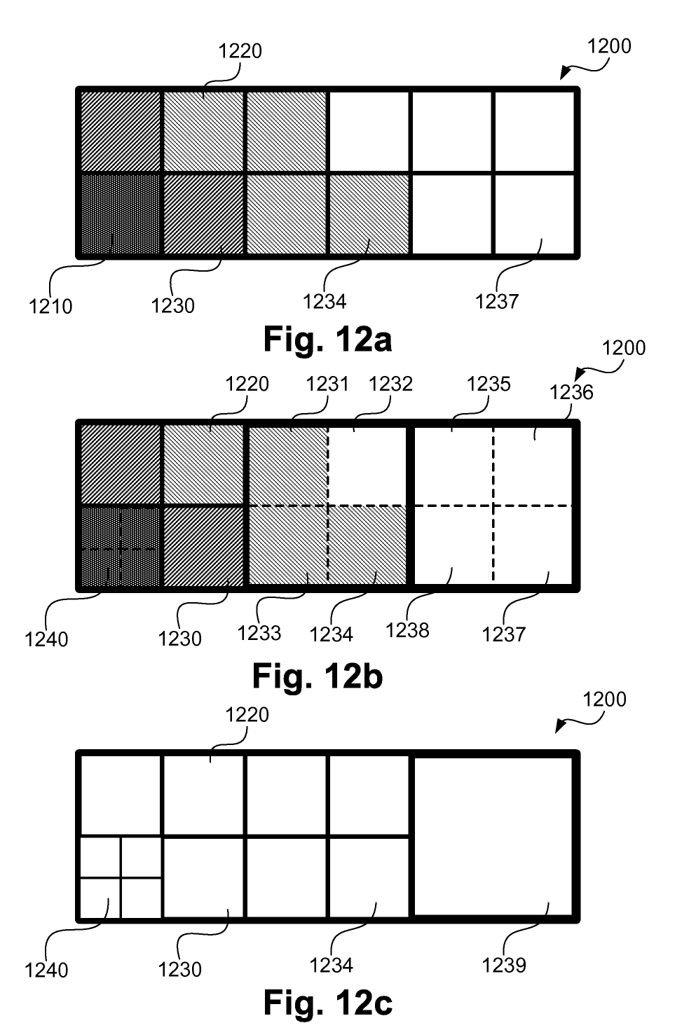

If at decision step 1150, the controller 102 determines that the foreground activity is below (or lower than) the second threshold, Yes, then control passes to step 1160. At step 1160, the controller 102 identifies neighbouring tessellation blocks which would merge with the selected tessellation block to make a larger tessellation block. The tessellation blocks identified at step 1160 may referred to as “merge blocks”. As an example, FIG. 12a shows a section 1200 of foreground activity map 1040, corresponding to an upper-middle section of the example foreground activity map 1040. Blocks with high activity 1210, medium activity 1230, low activity 1234, and no detected activity at all 1237, are shown in FIG. 12a. FIG. 12b shows the same section 1200 of the activity map 1040. With reference to FIG. 12a, for sample block 1237 the identified tessellation blocks (the merge blocks) including the neighbouring tessellation blocks to the above and left of the block 1237, as seen in FIG. 12b are merged into larger block 1297 as seen in FIG. 12c.

FIGS. 12a-12c indicate that if foreground activity in a first region (e.g. the block 1210) is higher than a threshold, then smaller blocks are assigned to the region. Further, if foreground activity in a second region (e.g. the block 1237) is lower than the threshold, then a larger block is assigned in the region. If foreground activity in the first region (i.e., block 1210) is higher than the foreground activity in the second region (i.e., block 1237), then size of the blocks assigned to the first region is smaller than the size of the blocks assigned to the second region (i.e., block 1237).

When the appropriate blocks have been identified, control passes to decision step 1162, where the controller 102 confirms whether each of the merge blocks have already been processed. If the merge blocks have not been processed, No, then the merge should not yet be performed and control passes to the completeness confirmation step 1170.

If at decision step 1162, the controller 102 determines that all of the merge blocks have been processed, Yes, then control passes to step 1164, in which the foreground activity of the merge blocks is aggregated by the controller 102. In one arrangement, the aggregation performed at step 1164 is a sum of the foreground activity of each of the merge blocks. In another arrangement, the aggregation is an arithmetic average of the activity of each of the merge blocks. In yet another arrangement, the aggregation involves a logarithmic operation to scale the values in a nonlinear manner before the values are summed together. Control then passes to decision step 1166, where if the controller 102 determines that the aggregated threshold is not below (or lower than) a threshold, No, then the tessellation blocks are not to be merged, and control passes to the completeness confirmation step 1170.

If at decision step 1166, the controller 102 determines that the aggregated activity is below (lower than) a threshold, Yes, then control passes to merging step 1168. At step 1168, the controller 102 merges the blocks and stores the merged blocks within the RAM 170. Control then passes to the completeness confirmation step 1170. In one arrangement, the activity is gathered or averaged to the largest scale and only the step of dividing blocks 1140 is performed. In one arrangement, the activity is gathered or interpolated to a smallest scale and only the step of merging blocks 1160, 1162, 1164, 1166, 1168 is performed.

In one arrangement, a second threshold may be used in step 1140, and one level of division (e.g., division into quarters), may be used if the level of activity is below (or lower than) that second threshold. Another level of division (e.g., division into sixteenths) may be used if the level of activity is equal to or greater than that second threshold. In another arrangement, still more thresholds may be used at the division step 1140.

In one arrangement, at the identification step 1160, the controller 102 begins at a largest scale possible for the identified tessellation block selected at step 1120. If the merge does not occur, then steps 1160, 1162, 1164, 1166 and 1168 are performed again for the next-largest scale, thus allowing higher levels of merging to occur in a single pass.

In one arrangement, the tessellation blocks selected at step 1120 are the tessellation blocks of the original activity map (e.g., 1010). In another arrangement, tessellation blocks resulting from division or merging may be marked as unprocessed and inserted into a database of tessellation blocks accessed at step 1120, allowing the method 1100 to recursively process the image at different scales.

In one arrangement, the method 1100 is first performed with the division step 1140 disabled. In this instance, a count may be kept of how many times the merging step 1168 is performed. The method 1100 may then be repeated with the blocks being processed in order of the level of activity detected, and a counter may be used to record how many times the division step 1140 is performed. The method 1100 may be aborted when the counter reaches the number of merging steps performed. Thus, the total number of blocks in the final tessellation is equal to the initial number of blocks used, allowing the final tessellation configuration to maintain a constant computational cost or memory cost when used.

In accordance with the method 1100, a number of visual element types may be selected. In one arrangement, three sizes of visual elements may be used including blocks of 4×4 pixels, blocks of 8×8 pixels, and blocks of 16×16 pixels.

As described above, FIG. 12b shows the section 1200 of the foreground activity map 1040, with different styles of lines showing the different block sizes considered for a tessellation of the scene of FIG. 10a. The activity level in block 1210 in FIG. 12a is high, and in accordance with the method 1100 of FIG. 11, the block 1210 is broken up into smaller blocks 1240, as at step 1140 of the method 1100.

Continuing the example, FIG. 12c shows a final hybrid-resolution tessellation of the merge sample blocks, determined in accordance with the method 1100. As seen in FIG. 12c, the broken-up blocks 1240 of FIG. 12b are seen in FIG. 12c to be at the small scale. If processing of the section 1200 is performed in raster-scan order, beginning at top left, proceeding to the right, and then beginning again at the bottom left and finishing at the bottom right, then the first low-activity block encountered will be block 1220. In accordance with the method 1100, for the example of FIGS. 12a to 12c, activity will be below (lower than) the merge threshold (as determined at step 1150). However, the other merge blocks will not yet be processed (as determined at step 1162).

As seen in FIG. 12a, blocks with medium activity (e.g., block 1230) do not have high enough activity to split (as determined at step 1130), or low enough activity to merge (as determined at step 1150). The medium activity blocks (e.g., 1230) therefore remain at the same size, as seen in FIG. 12b, such that the medium activity blocks (e.g., 1230) remain in the final tessellation as seen in FIG. 12c. Other blocks (e.g., block 1220) in the same larger block as the block 1230, thus do not have the opportunity to merge with each other, and also remain in the final tessellation as seen in FIG. 12c.

In accordance with the method 1100, when the block 1234 is reached, then all of the blocks (i.e., blocks 1231, 1232, 1233) in the same larger block as block 1234 will also have been processed (as determined at step 1162), and final activity in the larger block is aggregated. If the final level of activity is not lower than an activity threshold (as determined at step 1166), then the blocks (i.e., blocks 1231, 1232, 1233, 1234) are still not aggregated together.

Finally, in accordance with the method 1100, when the block 1237 is reached, then all of the blocks (i.e., blocks 1235, 1236, 1238) in the same larger block as the block 1237 have been processed. In accordance with the example of FIGS. 12a, 12b and 12c, the aggregated activity is lower than a threshold (as determined at step 1166), and so the blocks (i.e., blocks 1235, 1236, 1237, 1238) are aggregated together (as at step 1168) into a larger block 1239 as seen in FIG. 12c.

FIG. 13a shows a block 1310 of the scene model 330 of FIG. 3. The block 1310 has an associated visual element model 1320 comprising mode models 1330-1, 1330-2, and 1330-3.

As seen in FIG. 13b, the block 1310 is split up into four blocks 1340-1, 1340-2, 1340-3 and 1340-4 representing a part of the scene model 330. Each of the blocks 1340-1, 1340-2, 1340-3 and 1340-4, has an associated visual element model. For example, the blocks 1340-1 and 1340-2, each have an associated visual element model 1350 and 1370, respectively, allowing the creation of a new hybrid-resolution scene model from the existing scene model 330. The new hybrid-resolution scene model may have a new tessellation as shown in FIG. 10c.

To create the new hybrid scene model, each mode model 1330-1, 1330-2 and 1330-3 of the original visual element model 1320 is split up into corresponding mode models 1360-1, 1360-2, and 1360-3 of visual element model 1350 associated with smaller block 1340-1; and corresponding mode models 1380-1, 1380-2, and 1380-3 of visual element model 1370 associated with smaller block 1340-2. In one arrangement, temporal properties of each original mode model (e.g., model 1330-1, 1330-2 and 1330-3) may be directly copied to properties of the corresponding mode models (e.g., 1360-1, 1360-2, and 1360-3). In one arrangement, the original mode models (e.g., 1330-1, 1330-2 and 1330-3) contain a representation of the visual content of the scene as pixels, and the creation of the corresponding mode models (e.g., model 1360-1, 1360-2 and 1360-3) involves taking an appropriate subset of the pixels. In still another arrangement, the original mode models (e.g., model 1330-1, 1330-2 and 1330-3) contain a representation of the visual content of the scene as DCT coefficients, and the creation of the corresponding mode models (e.g., 1360-1, 1360-2, and 1360-3) involves transforming the coefficients in the DCT domain to produce corresponding sets of DCT coefficients representing an appropriate subset of visual information.

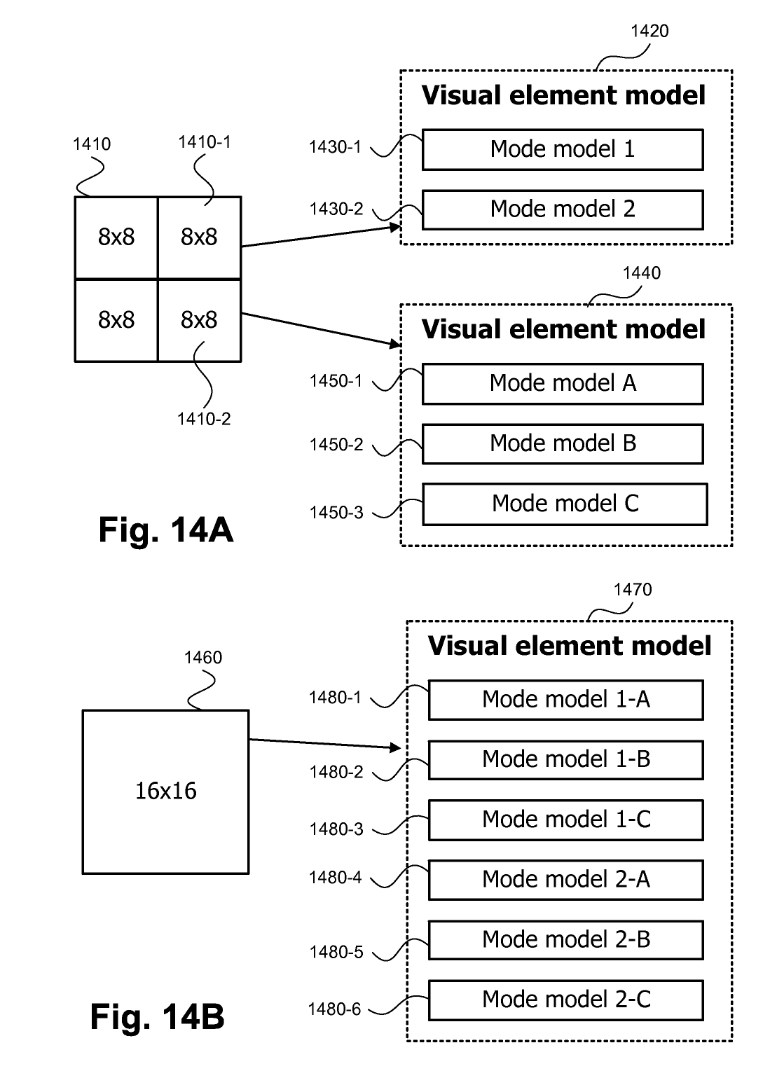

FIG. 14a shows a set of blocks in a scene model 1410. The set of blocks includes blocks 1410-1 and 1410-2 with corresponding visual element models 1420 and 1440, respectively, as seen in FIG. 14b, the set of blocks of FIG. 14a may be merged together into a larger block 1460. The block 1460 has a corresponding visual element model 1470. The block 1460 allows the creation of a new hybrid-resolution scene model from the existing scene model 1410, in accordance with a new tessellation as shown in FIG. 10c.

To create the mode models 1480-1 to 1480-6 of visual element model 1470, the mode models 1430-1 and 1430-2 of the component visual element model 1420, and the mode models 1450-1, 1450-2 and 1450-3 of the component visual element model 1440, may be combined exhaustively to produce every combination mode model of the visual element model 1470 (i.e., mode model 1-A, 1480-1, mode model 1-B, 1480-2, mode model 1-C, 1480-3, mode model 2-A, 1480-4, mode model 2-B, 1480-5, and mode model 2-C 1480-6). In one arrangement, temporal properties of each component mode model of each combination mode model are averaged. In another arrangement, the smaller value of each temporal property is retained.

In one arrangement, the mode models 1430-1, 1430-2, 1450-1, 1450-2 and 1450-3 contain a representation of the visual content of the scene of FIG. 10a as pixels, and the creation of the corresponding mode models 1480-1 to 1480-6 involves concatenating the groups of pixels together. In another arrangement, the mode models 1430-1, 1430-2, 1450-1, 1450-2 and 1450-3 contain a representation of the visual content of the scene as DCT coefficients. The creation of the corresponding mode models 1480-1 to 1480-6 involves transforming the coefficients in the DCT domain to produce corresponding sets representing the appropriate concatenation of the visual information.

In one arrangement, not all combinations of the mode models 1430-1, 1430-2, 1450-1, 1450-2 and 1450-3 of the component visual element models 1420 and 1440 are considered for creation of the resulting mode models 1480-1 to 1480-6 of the resulting visual element model 1470. In one arrangement, only mode models with similar temporal properties are combined. In another arrangement, correlation information is kept regarding the appearance of different mode models together, and only mode models with a correlation greater than a threshold are combined.

In yet another arrangement, all combinations of mode models are created but are given a temporary status. In this instance, the combinations of mode models are deleted after a given time period (e.g., 3,000 images), if the mode models are not matched.

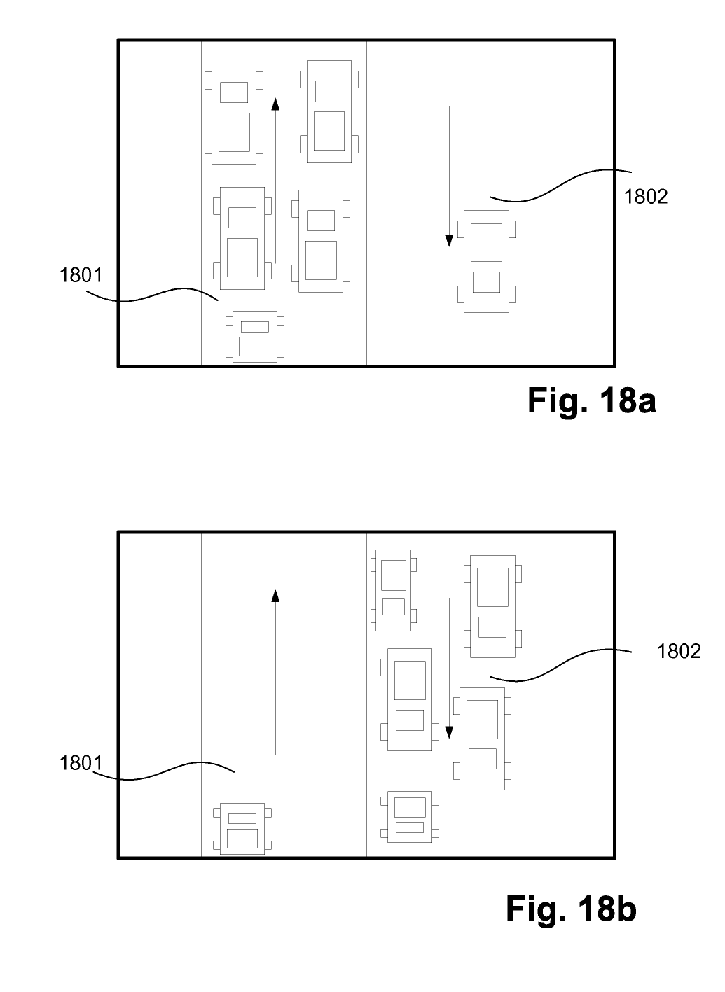

To determine (or update) a foreground activity map, as at step 920 of the method 900, and to update each block size for a scene model, a ‘trigger’ may be used as described below. In some examples, the foreground activity over a field of view may change considerably with time. For example, FIG. 18a shows an example where the field of view consists of two lanes on a road. The lane 1801 is for traffic in an opposite direction to the lane shown 1802. In the example of FIG. 18a, there is high foreground activity in the morning in a region formed by lane 1801. In contrast, there is high foreground activity in a region formed by lane 1802 in the evening as shown in FIG. 18b. In the example shown in FIGS. 18a and 18b, there is a need to re-estimate the foreground activity map and scene resolution tessellation.

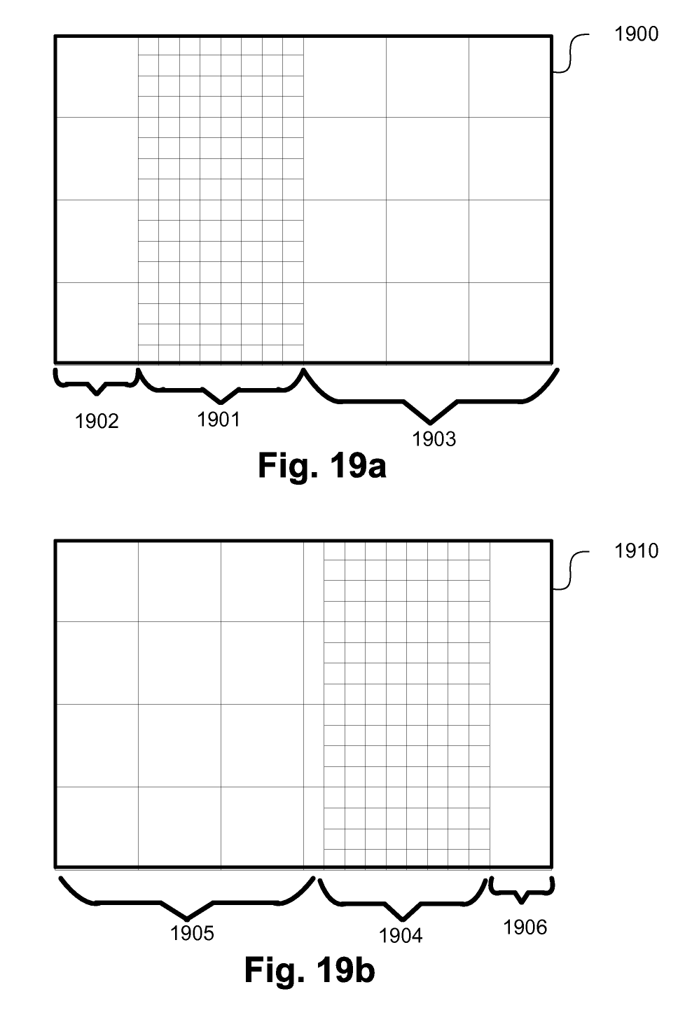

FIG. 19a shows a scene model tessellation 1900 for the field of view corresponding to foreground activity shown in FIG. 18a. The scene model tessellation 1900 has smaller size blocks in a region 1901 of the tessellation 1900 corresponding to the region of lane 1801 due to high foreground activity in the lane 1801 in the example of FIG. 18a. The remaining regions 1902 and 1903 of the tessellation 1900 have larger size blocks due to low foreground activity.

Updating a foreground activity map is based on a ‘trigger’. A trigger refers to an event which indicates that a new scene model tessellation should be determined.

In one arrangement, average number of foreground activity is determined for a region represented by larger size blocks for a number of current frames. Accumulated foreground activity may be updated if foreground activity for blocks in the number of current frames is similar. In one arrangement, the number of frames may be one-hundred and fifty (150) which is equivalent to five (5) seconds duration for a thirty (30) frames per second video. Additionally, an average number of foreground activity is determined for a region represented by smaller size blocks and then average foreground activity of the two regions is compared. In this instance, a trigger is raised if the result of the comparison is that average foreground activity of the two regions is similar. In one arrangement, the foreground activity of the two regions is similar when the difference between the foreground activity for each of the two regions is less than twenty (20).

If a trigger occurs, the foreground activity map for a scene following the execution of the method 900 is updated and a new scene model tessellation is generated. FIG. 19b shows an example scene model tessellation 1910 corresponding to the scene activity shown in FIG. 18b. The scene model tessellation 1910 has smaller size blocks in a region 1904 corresponding to the region of lane 1802 due to high foreground activity in the lane 1802 in the example of FIG. 18b. The remaining regions 1905 and 1906 of the tessellation 1910 have larger size blocks due to low foreground activity.

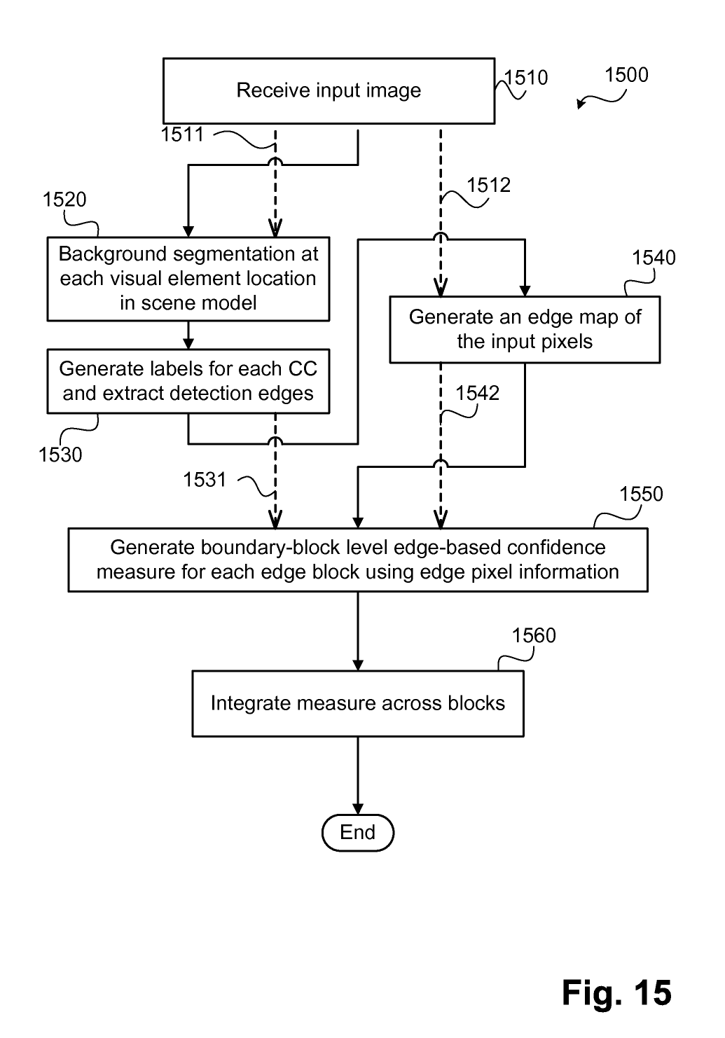

Foreground activity found through processing may include “False positive” detections. The “False positive” detections are usually the result of noise or semantically-meaningless motion. A method 1500 described below with reference to FIG. 15 may be used to determine whether a detection is a false positive or true positive.

FIG. 15 is a flow diagram showing the method 1500 of determining whether a detection of activity is a false positive. The method 1500 may be implemented as one or more code modules of the software application program 133 resident in the ROM 160 and being controlled in its execution by the controller 102.

The method 1500 begins at receiving step 1510, where the controller 102 receives an input image. The input image may be stored within the RAM 170 when the image is received by the controller 102.

At the next background subtraction step 1520, the controller 102 performs background segmentation at each visual element location of a scene model of the input image. In one arrangement, the method 400 is executed on the input image at step 1520. In another arrangement, the processor 105 may produce a result based on the colour or brightness of the content of the scene, at step 1520. In yet another arrangement, a hand-annotated segmentation of the scene is provided for evaluation at step 1520.

The method 1500 then proceeds to a connected-component analysis step 1530, where the controller 102 identifies which of the connected components of the input image lie on the detection boundaries. A segmentation is provided to classify at least all of the visual elements associated with a given connected component. In one arrangement, the visual elements are individual pixels. In another arrangement, each visual element encompasses a number of pixels.

As seen in FIG. 15, at generating step 1540, an edge map is generated from the input visual elements of the input image stored in RAM 170. In one arrangement, a Canny edge detector may be used at step 1540. In another arrangement, a Sobel edge detector may be used at step 1540. In one arrangement, the same visual element is used at step 1540 as in steps 1520 and 1530. In another arrangement, multiple edge values are generated for each visual element. In yet another arrangement, a single edge value is applied to multiple visual elements at step 1540.

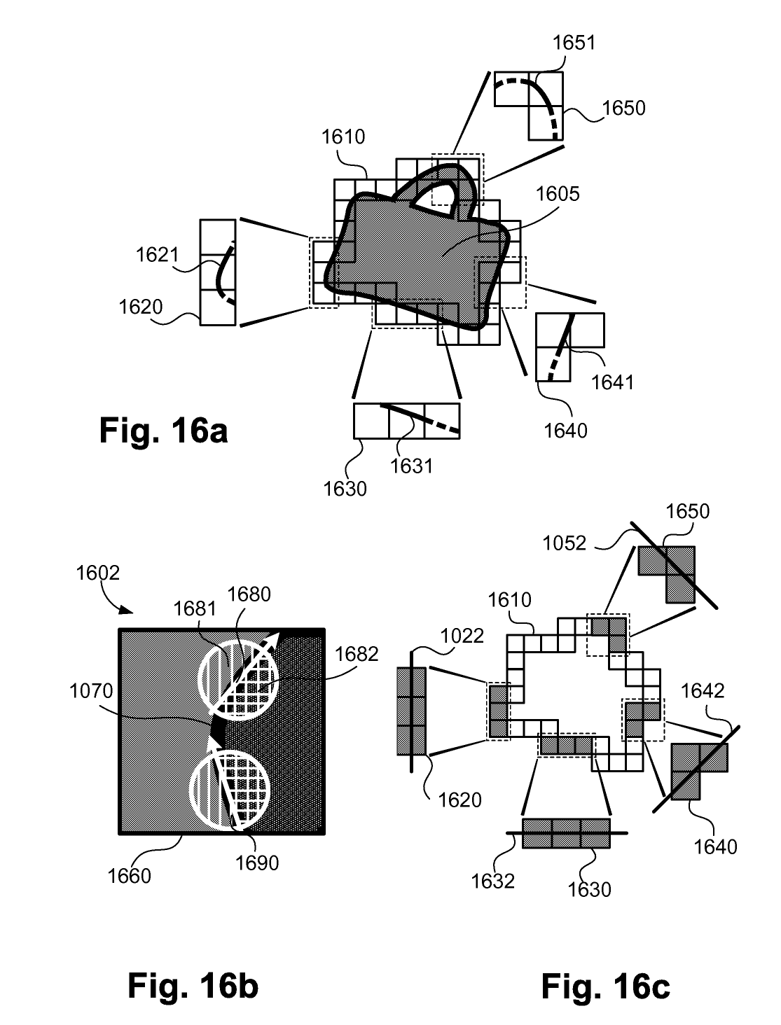

Processing then continues to generating step 1550, where the controller 102 generates block-level confidence measures and stores the confidence measures within the RAM 170. The boundaries of the connected components and the detected edges are used at step 1550 to generate the block-level confidence measures. For each boundary visual element received, a confidence measure is generated at step 1550. In one arrangement, a score (e.g., one (1)) is given for each boundary block for which the edge strength exceeds a predetermined threshold. Alternatively, a zero (0) score is given for each boundary block if there is no edge value corresponding to the block for which the edge strength is sufficiently strong. In another arrangement, a contrast-based measure may be used at step 1550 to generate the confidence measures. For example, FIG. 16b shows a construct by which contrast may be measured on either side of an edge at a boundary block. The construct of FIG. 16b will be described in detail below.

In yet another arrangement, an edge-alignment-based measure may be used at step 1550 to generate the confidence measures, as will be described below with reference to FIGS. 16a and 16b.

The contrast-based confidence measure 602 shown in FIG. 16b uses the spatial colour contrast along an edge identified within each boundary block. Such a confidence measure is based on the assumption that colour of a background is different from the colour of foreground objects. Such an assumption usually holds true because most background subtraction methods determine which regions of an image belong to the foreground by determining colour difference between the input image and a scene model of the input image.

In order to determine the contrast-based confidence measure in accordance with the example of FIG. 16b, edge detection (e.g., Canny edge detection), may be performed on the gray-level image to obtain the edge magnitude and orientation at each edge point. As seen in FIG. 16b, in a boundary block 1660 a circular disk with a predefined radius r is centred at each edge point (e.g., 1680) and 1690. The disk 1680 is split into two half-disks 1681 and 182 based on the edge orientation at the edge point. In one arrangement, the radius used may be seven (7) pixels, so that each half-disc contains π×7²/2=seventy six (76) pixels, a value comparable to the number of pixels in an 8×8 block (i.e., 64 pixels). The colour components of a pixel inside the two half-disks may be defined as C_{B} and C₀, respectively. In one arrangement, the confidence value for a boundary block, \tilde{v}_{C}, may be determined in accordance with Equation (2) as follows:

$${\tilde{v}}_{C} = \frac{1}{{N}_{p}} {\sum }_{n = 1}^{{N}_{p}} \frac{{‖ {C}_{B} ( n ) - {C}_{O} ( n ) ‖}_{2}}{\sqrt{3} \times 255} \qquad ( 2 )$$

where Nₚ represents the total number of edge points in the boundary block, and ∥C_{B}(n)−C₀(n)∥₂ is the Euclidean norm between two colour component vectors.

In one arrangement, the YUV colour space may be selected to determine the colour difference at step 1550. In another arrangement, an YCbCr colour space may be used to determine the colour difference at step 1550. In still another arrangement, an HSV (Hue-Saturation-Value) colour space may be used to determine the colour difference at step 1550. In yet another arrangement, a colour-opponent L*a*b colour space may be used at step 1550. In yet another arrangement, an RGB (Red-Green-Blue) colour space may be used at step 1550 to determine the colour difference. Moreover, the colour difference may be determined at step 1550 using colour histograms with different distance metrics such as histogram intersection and χ² distance. The factor of \sqrt{3} normalises for three channels (RGB) to scale \tilde{v}_{C} between zero (0) and one (1).

In one arrangement, the confidence value for the set of connected boundary blocks with the block label l_{B} is determined by taking the average of \tilde{v}_{C}: in accordance with Equation (3), as follows:

$${\tilde{V}}_{C}^{( {l}_{B} )} = \frac{1}{{N}_{B}} {\sum }_{n = 1}^{{N}_{B}} {\tilde{v}}_{C} ( n ) \qquad ( 3 )$$

Then the contrast-based confidence measure for the foreground region with the region label l_{R} may be expressed in accordance with Equation (4), as follows:

$${V}_{C}^{( {l}_{R} )} = \frac{1}{{N}_{{l}_{R}}} {\sum }_{n = 1}^{{N}_{{l}_{R}}} {\tilde{V}}_{C}^{( {l}_{B} )} ( n ) . \qquad ( 4 )$$

The larger the value of V_{C}^{(l}^{_{R}}⁾ (e.g., the closer the value is to one (1.0) for example), the better the detection quality is for a region.

An edge-alignment measure may be used to determine the confidence measure at step 1550. Such an edge-alignment-based measure will now be described with reference to FIGS. 16a and FIG. 16c. The edge-alignment-based measure uses different methods to measure edge alignment in each block, to examine agreement between a boundary and content edges, in order to determine whether the boundary is appropriate. Such an edge-based confidence measure determines similarity between orientations of a set of connected boundary blocks and edge orientations estimated from image patches within the connected boundary blocks. Determination of the edge-based confidence measure requires edge orientation prediction and estimation.

As described above, an edge-alignment-based measure may be used at step 1550 to generate the confidence measures at step 1550. For example, FIG. 16a shows boundary blocks 1610 around a detected object in the form of a bag 1605. FIG. 16c shows the same set of boundary blocks 1610 without the bag.

To estimate edge orientation, in one arrangement, a boundary block and neighbouring boundary blocks (e.g., neighbouring block 1620, 1630, 1640, and 1650) are examined. Such an examination shows an edge 1621, 1631, 1641 and 1651 contained within the blocks 1620, 1630, 1640 and 1650, respectively. To determine the orientation of the edge (i.e., 1621, 1631, 1641 and 1651), in one arrangement, a partitioning-based method may be applied to determine the gray-level image patch within a boundary block. In this instance, the boundary block under consideration is partitioned into four sub-blocks R₁₁, R₁₂, R₂₁, and R₂₂, respectively. The edge orientation is estimated based on distribution value ρ_{θ}_{ₑ}, which is calculated using R₁₁, R₁₂, R₂₁, and R₂₂, as in Table 1, below. The estimated edge orientation θₑε{0°,45°,90°,135°} for a boundary block corresponds to the orientation, which has the largest distribution value ρ_{θ}_{ₑ}.

TABLE 1
Estimated edge orientations and the corresponding distribution values

| Estimated | |
|---|---|
| edge | |
| orientation | |
| θₑ | Distribution value ρ_{θ}_{ₑ} |
| 0° | $\vert \frac{{R}_{11} + {R}_{12}}{2} - \frac{{R}_{21} + {R}_{22}}{2} \vert$ |
| 45° | $max \{ \vert {R}_{11} - \frac{{R}_{12} + {R}_{21} + {R}_{22}}{3} \vert , \vert {R}_{22} - \frac{{R}_{11} + {R}_{12} + {R}_{21}}{3} \vert \}$ |
| 90° | $\vert \frac{{R}_{11} + {R}_{21}}{2} - \frac{{R}_{12} + {R}_{22}}{2} \vert$ |
| 135° | $max \{ \vert {R}_{12} - \frac{{R}_{11} + {R}_{21} + {R}_{22}}{3} \vert , \vert {R}_{21} - \frac{{R}_{11} + {R}_{12} + {R}_{22}}{3} \vert \}$ |

Orientation of a boundary block may be predicted by considering relationship of the boundary block with two neighbouring boundary blocks. For example, FIG. 16c shows four types of connected boundary block configurations 1620, 1630, 1640 and 1650, and corresponding orientations predicted for the boundary block under consideration 1622, 1632, 1642 and 1652, respectively. The predicted orientation for a boundary block, θₚ, has one of four values, i.e., θₚε{0°, 45°, 90°, 135°}. If a boundary block has either more or less than two neighbours in a four (4)-connected neighbourhood (i.e., the block configuration is different from the types of boundary block configurations illustrated in FIG. 16c, then such a boundary block is ignored in the estimation and predicted orientation of the boundary block is assigned to be 90°.

The predicted orientation and the estimated edge orientation of a boundary block are compared. The difference between the predicted orientation and the estimated edge orientation indicates the detection confidence for the boundary block under consideration. In one arrangement, obtaining the predicted and estimated orientations for the boundary blocks with the same block label l_{B}, the confidence value for the set of connected boundary blocks, \tilde{V}_{E}^{(l}^{_{B}}⁾, is determined by determining the average of the absolute differences between the predicted and estimated orientations, in accordance with Equation (5), below:

$${\tilde{V}}_{E}^{( {l}_{B} )} = \frac{1}{{N}_{B}} {\sum }_{n = 1}^{{N}_{B}} \frac{\vert {θ}_{p} ( n ) - {θ}_{e} ( n ) \vert}{180} \qquad ( 5 )$$

where N_{B} is the total number of boundary blocks in the set of connected boundary blocks. The edge-based confidence measure for the foreground region with the region label l_{R} is expressed as in accordance with Equation (6), below:

$${V}_{E}^{( {l}_{R} )} = \frac{1}{{N}_{{l}_{R}}} {\sum }_{n = 1}^{{N}_{{l}_{R}}} {\tilde{V}}_{E}^{( {l}_{B} )} ( n ) \qquad ( 6 )$$

where Nₗ_{_{R}} is the total number of connected boundary blocks in the region. The values of \tilde{V}_{E}^{(l}^{_{B}}⁾ and V_{E}^{(l}^{_{R}}⁾ lie between zero (0) and one (1). The smaller the value of V_{E}^{(l}^{_{R}}⁾ is, the better the detection quality is for the region.

In one arrangement, the methods described above are performed upon all of the boundary blocks of the detected parts of the image. In another arrangement, the methods described above are applied only to sections which have changed from a previous image in a video sequence of images.

Once the level of confidence has been determined at step 1550, control continues to integration step 1560, where the processor 105 integrates the confidence measure determined at step 1550 across blocks. In one arrangement, a boundary-level integrated measure is determined to evaluate each connected component. In another arrangement, a frame-level integrated measure is determined to evaluate each processed image of a sequence of images.

In one arrangement, a region-level integrated measure may be used to determine the confidence measure at step 1550. A region-level integrated measure produces region-level confidence values for the regions within a given image of a video sequence. A confidence value generated by such a region-level integrated measure for a region is comprised of confidence values determined from the edge-based and the contrast-based confidence measures for all the connected boundary blocks within the region. In one arrangement, the region-level integrated measure for a region with the label l_{R} is expressed in accordance with Equation (7), below:

$${V}_{IR}^{( {l}_{R} )} = \frac{1}{{N}_{{l}_{R}}} {\sum }_{n = 1}^{{N}_{{l}_{R}}} {\tilde{V}}_{IR}^{( {l}_{B} )} ( n ) \qquad ( 7 )$$

where Nₗ_{_{R}} represents the total number of connected boundary blocks in the region and \tilde{V}_{IR}^{(l}^{_{B}}⁾(n) denotes the confidence measure for a set of connected boundary blocks with the label l_{B} which is expressed in accordance with Equation (8), below:

$${\tilde{V}}_{IR}^{( {l}_{B} )} = \{ \begin{matrix}\frac{{\tilde{V}}_{C}^{( {l}_{B} )}}{{w}_{C}} + \frac{1 - {\tilde{V}}_{E}^{( {l}_{B} )}}{{w}_{E}} , & if {N}_{B} \geq {N}_{B}^{TH} \\ \frac{{\tilde{V}}_{C}^{( {l}_{B} )}}{{w}_{C}} , & otherwise\end{matrix} \qquad ( 8 )$$

where N_{B} represents the total number of boundary blocks in the set of connected boundary blocks, N_{B}^{TH}, represents a predefined threshold and w_{E} and w_{C} are the normalisation factors. Further, \tilde{V}_{E}^{(l}^{_{B}}⁾ and \tilde{V}_{C}^{(l}^{_{B}}⁾ represent the edge-based and the contrast-based measures, respectively. The predefined threshold, N_{B}^{TH}, is determined based on the minimum number of boundary blocks needed for integration. The orientation prediction of the edge-based confidence measure requires at least three connected boundary blocks. Therefore, the threshold, N_{B}^{TH}, may be selected to be three (3). The normalisation factors w_{E} and w_{C} are used for normalising the confidence values of the edge-based and contrast-based measures to each other. The larger the value of V_{IR}^{(l}^{_{R}}⁾, the better the detection quality is for the region.

In one arrangement, a frame-level integrated measure may be used to determine the confidence measure at step 1550. A frame-level integrated measure produces a confidence value for a given image and it is constructed based on the edge-based measure and contrast-based measure, V_{E}^{(l}^{_{R}}⁾ and V_{C}^{(l}^{_{R}}⁾. In one arrangement, the frame-level integrated measure, V_{IF}, is expressed in accordance with Equation (9), below:

$${V}_{IF} = \frac{1}{{N}_{R}} {\sum }_{n = 1}^{{N}_{R}} \frac{{V}_{E}^{( {l}_{R} )}}{{V}_{C}^{( {l}_{R} )} + ɛ} \qquad ( 9 )$$

where N_{R} represents the total number of regions within a given image ands is a small number used to avoid dividing by zero (e.g., 0.01). The smaller the value of V_{IF} is, the better the detection quality is for an image. A sequence-level confidence value is directly determined by taking the average of the frame-level confidence values of all the images of a video sequence.

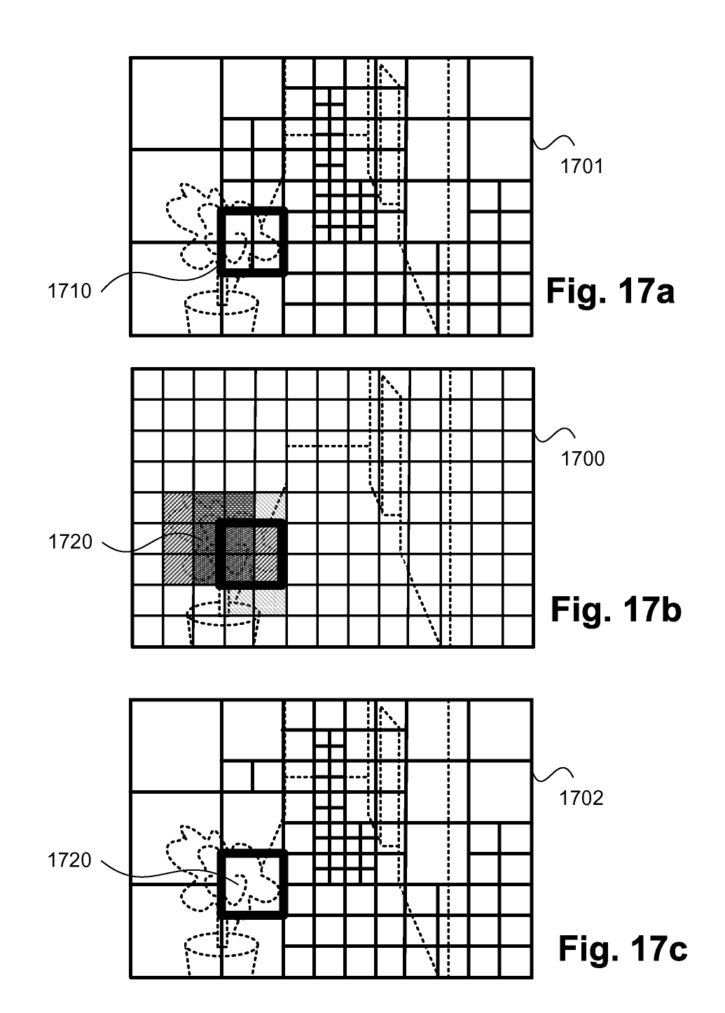

When the integration of the measures has been completed at step 1560, the method 1500 concludes. In one arrangement, a final score for each region may be evaluated to form a map 1700 of low-scoring boundary locations, as shown in FIG. 17b, which will be described in further detail below. In another arrangement, low-scoring connected components may be removed from a set of detected results before further processing continues. In yet another arrangement, further processing is unaffected but results are presented to a system user. In yet another arrangement, a frame-level score may be used to evaluate whether the segmentation performed at step 1520 is producing valuable results. In yet another arrangement multiple segmentation processes may be executed in parallel to determine which segmentation process produces more valuable results.

The methods described above may be further modified by including information from the automatic identification of false positive detections, as will now be described with reference to FIGS. 17a, 17b and 17c. FIG. 17a shows a tessellation corresponding to the tessellation shown in FIG. 10c. As shown in FIGS. 10a and 10b, the region corresponding to the plant 1023 resulted in detected activity (e.g., as represented by block 1033), and correspondingly the tessellation in the region 1710 has relatively small blocks. The small blocks are likely to result in further activity detections. If larger blocks were used at the location of region 1710, then the final tessellation would suffer less from false detections, which is desirable.

As described above, at step 930, the controller 102 accumulates the detected foreground activity, represented by the foreground activity maps, into a single foreground activity map 1040. In a similar manner, false-positive detections may be accumulated into a false-positive-activity map. Such a false-positive-activity map 1700 is shown in FIG. 17b. The map 1700 highlights an area 1720 of high false-positive activity.

The area 1720 of high false-positive activity may be used to influence the methods described above by which the tessellation is formed (i.e., size of blocks is determined). For example, the methods may be configured for detecting false positive foreground activity and modifying size of at least one of the plurality of blocks based on the detected false positive foreground activity. The area 1720 of high false-positive activity may also be used to modify the final tessellation (i.e., size of at least one block), such that the result a larger block at the false-positive-activity location 1730. In one arrangement, false-positive detections may be identified at step 920 and are not accumulated into the activity map at step 930.

In another arrangement, false-positive detections may be identified in step 920 and accumulated in a new step similar to step 930. The accumulated false-positive-activity map may then be subtracted from the accumulated foreground activity map generated in step 930 before control passes to step 940.

In yet another arrangement, a second process may be performed in parallel to execution of the method 900 in order to perform false-positive detection. In this instance, a false-positive-activity map (e.g., 1700) may be accumulated in a manner similar to steps 920 and 930. The false-positive-activity map 1700, as seen in FIG. 17b, may then be used in a process similar to step 940 in FIG. 11. The input to such a process similar to step 940 is the false-positive-activity map 1700 and final tessellation map 1701 as seen in FIG. 17a. Using the false-positive-activity map 1700 and final tessellation map 1701 in such a process, steps 1130, 1150 and 1166 may have their logic inverted such that areas of high false-positive-activity (e.g., region 1720) are merged together (as at step 1168), to obtain modified tessellation map 1702 as seen in FIG. 17c.

### INDUSTRIAL APPLICABILITY

The arrangements described are applicable to the computer and data processing industries and particularly for the imaging and video industries.

The foregoing describes only some embodiments of the present disclosure, and modifications and/or changes can be made thereto without departing from the scope and spirit of the present invention as defined in the claims that follow, the embodiments being illustrative and not restrictive.

1. A method of segmenting an image into foreground and background regions, said method comprising:
dividing the image into a plurality of blocks;
receiving a first plurality of mode models of a first size for a first block and a second plurality of mode models of a second size for a second block, wherein if foreground activity in the first block is higher than the foreground activity in the second block, the first size is smaller than the second size; and
segmenting the image into foreground and background regions based on the received mode models.

2. The method according to claim 1, comparing each of the plurality of blocks in the image with a corresponding block in a scene model for the image to determine whether each of plurality of blocks is a foreground region or a background region.

3. The method according to claim 2, wherein the segmenting step comprises determining a spatial support value which is independent of size of mode models in a block neighbouring a block to be segmented if the block neighbouring the block to be segmented is larger than the block to be segmented.

4. The method according to claim 2, wherein the segmenting step comprises determining a spatial support value which is dependent on size of mode models in blocks neighbouring the block to be segmented if the blocks neighbouring the block to be segmented are smaller than the block to be segmented.

5. The method according to claim 1, wherein the foreground activity is accumulated based on a number of images.

6. The method according to claim 5, wherein the number of images processed to accumulate the foreground activity is determined in an event that accumulated foreground activity satisfies a predetermined level of activity.

7. The method according to claim 5, wherein the number of images processed to accumulate the foreground activity is determined based on the difference between first previously accumulated foreground activity and second previously accumulated foreground activity.

8. The method according to claim 5, further comprising:
detecting a false positive foreground activity; and
modifying a size of at least one of the plurality of blocks based on the detected false positive foreground activity.

9. The method according to claim 5, wherein the accumulated foreground activity is updated if foreground activity for the first and second blocks for a number of current frames are similar.

10. The method according to claim 1, wherein stillness measure is used instead of the foreground activity.

11. The method according to claim 1, wherein said blocks are comprised of frequency domain coefficients, the number of frequency domain coefficients in each block being dependant on the size of blocks.

12. An apparatus for segmenting an image into foreground and background regions, said apparatus comprising:
a memory for storing data and a computer program;
a processor coupled to said memory for executing said computer program, said computer program comprising instructions for:
dividing the image into a plurality of blocks;
receiving a first plurality of mode models of a first size for a first block and a second plurality of mode models of a second size for a second block, wherein if foreground activity in the first block is higher than the foreground activity in the second block, the first size is smaller than the second size; and
segmenting the image into foreground and background regions based on the received mode models.

13. A computer readable medium comprising a computer program stored thereon for segmenting an image into foreground and background regions, said program comprising:
code for dividing the image into a plurality of blocks;
code for receiving a first plurality of mode models of a first size for a first block and a second plurality of mode models of a second size for a second block, wherein if foreground activity in the first block is higher than the foreground activity in the second block, the first size is smaller than the second size; and
code for segmenting the image into foreground and background regions based on the received mode models.

14. A method of segmenting an image into foreground and background regions, said method comprising:
segmenting the image into foreground and background regions by comparing a block of the image with a corresponding block in a scene model for the image, said block of the image and the corresponding block being obtained at a predetermined block size;
accumulating foreground activity in the block of the image based on the segmentation;
altering the block size of the image, in an event that the accumulated foreground activity satisfies a pre-determined threshold; and
determining a further scene model corresponding to the altered block size.

15. An apparatus for segmenting an image into foreground and background regions, said apparatus comprising:
a memory for storing data and a computer program;
a processor coupled to said memory for executing said computer program, said computer program comprising instructions for:
segmenting the image into foreground and background regions by comparing a block of the image with a corresponding block in a scene model for the image, said block of the image and the corresponding block being obtained at a predetermined block size;
accumulating foreground activity in the block of the image based on the segmentation;
altering the block size of the image, in an event that the accumulated foreground activity satisfies a pre-determined threshold; and
determining a further scene model corresponding to the altered block size.

16. A computer readable medium comprising a computer program stored thereon segmenting an image into foreground and background regions, said program comprising:
code for segmenting the image into foreground and background regions by comparing a block of the image with a corresponding block in a scene model for the image, said block of the image and the corresponding block being obtained at a predetermined block size;
code for accumulating foreground activity in the block of the image based on the segmentation;
code for altering the block size of the image, in an event that the accumulated foreground activity satisfies a pre-determined threshold; and
code for determining a further scene model corresponding to the altered block size.
